(19) United States
(12) Patent Application Publication
(10) Pub. No.: US 2014/0096764 A1
(43) Pub. Date: Apr. 10, 2014

(54) BIOMASS CONVERSION SYSTEMS AND METHODS FOR USE THEREOF

(71) Applicant: SHELL OIL COMPANY, Houston, TX (US)

(72) Inventors: Glenn Charles KOMPLIN, Katy, TX (US); Joseph Broun Powell, Houston, TX (US)

(21) Appl. No.: 14/045,262

(22) Filed: Oct. 3, 2013

Related U.S. Application Data
(60) Provisional application No. 61/710,916, filed on Oct. 8, 2012.

(51) Int. Cl. C08B 1/00

(52) U.S. Cl. CPC C08B 1/00
USPC 127/1; 127/37

(57) ABSTRACT

Digestion of cellulosic biomass solids to form a hydrolysate may be accompanied by decomposition if the soluble carbohydrates produced from the biomass under hydrothermal digestion conditions are not transformed into a more stable reaction product. Biomass conversion systems may be configured to address this issue and others. Biomass conversion systems can comprise: a hydrothermal digestion unit; a first catalytic reduction reactor unit fluidly coupled to the hydrothermal digestion unit along its height by two or more fluid inlet lines and two or more fluid return lines, the first catalytic reduction reactor unit containing a catalyst capable of activating molecular hydrogen; and a fluid circulation loop comprising the hydrothermal digestion unit and a second catalytic reduction reactor unit that contains a catalyst capable of activating molecular hydrogen.

### RELATED APPLICATIONS

This application claims the benefit of U.S. Provisional Application No. 61/710,916, filed on Oct. 8, 2012, the disclosure of which is incorporated herein by reference in its entirety.

### TECHNICAL FIELD

The present disclosure generally relates to digestion of cellulosic biomass solids, and, more specifically, to biomass conversion systems and methods for use thereof that allow a hydrolysate comprising soluble carbohydrates to be rapidly converted into a more stable reaction product following hydrothermal digestion.

### BACKGROUND

This section is intended to introduce various aspects of the art, which may be associated with exemplary embodiments of the present invention. This discussion is believed to assist in providing a framework to facilitate a better understanding of particular aspects of the present invention. Accordingly, it should be understood that this section should be read in this light, and not necessarily as admissions of any prior art.

A number of substances of commercial significance may be produced from natural sources, particularly biomass. Cellulosic biomass may be particularly advantageous in this regard due to the versatility of the abundant carbohydrates found therein in various forms. As used herein, the term “cellulosic biomass” refers to a living or recently living biological material that contains cellulose. The lignocellulosic material found in the cell walls of higher plants is the world's most abundant source of carbohydrates. Materials commonly produced from cellulosic biomass may include, for example, paper and pulpwood via partial digestion, and bioethanol by fermentation.

Plant cell walls are divided into two sections: primary cell walls and secondary cell walls. The primary cell wall provides structural support for expanding cells and contains three major polysaccharides (cellulose, pectin, and hemicellulose) and one group of glycoproteins. The secondary cell wall, which is produced after the cell has finished growing, also contains polysaccharides and is strengthened through polymeric lignin that is covalently crosslinked to hemicellulose. Hemicellulose and pectin are typically found in abundance, but cellulose is the predominant polysaccharide and the most abundant source of carbohydrates. The complex mixture of constituents that is co-present with the cellulose can make its processing difficult, as discussed hereinafter.

Significant attention has been placed on developing fossil fuel alternatives derived from renewable resources. Cellulosic biomass has garnered particular attention in this regard due to its abundance and the versatility of the various components found therein, particularly cellulose and other carbohydrates. Despite promise and intense interest, the development and implementation of bio-based fuel technology has been slow. Existing technologies have heretofore produced fuels having a low energy density (e.g., bioethanol) and/or that are not fully compatible with existing engine designs and transportation infrastructure (e.g., methanol, biodiesel, Fischer-Tropsch diesel, hydrogen, and methane). Energy- and cost-efficient processes for processing cellulosic biomass into fuel blends having similar compositions to fossil fuels would be highly desirable to address the foregoing issues and others.

When converting cellulosic biomass into fuel blends and other materials, cellulose and other complex carbohydrates therein can be extracted and transformed into simpler organic molecules, which can be further reformed thereafter. Fermentation is one process whereby complex carbohydrates from cellulosic biomass may be converted into a more usable form. However, fermentation processes are typically slow, require large volume reactors and high dilution conditions, and produce an initial reaction product having a low energy density (ethanol). Digestion is another way in which cellulose and other complex carbohydrates may be converted into a more usable form. Digestion processes can break down cellulose and other complex carbohydrates within cellulosic biomass into simpler, soluble carbohydrates that are suitable for further transformation through downstream reforming reactions. As used herein, the term “soluble carbohydrates” refers to monosaccharides or polysaccharides that become solubilized in a digestion process. Although the underlying chemistry is understood behind digesting cellulose and other complex carbohydrates and further transforming simple carbohydrates into organic compounds reminiscent of those present in fossil fuels, high-yield and energy-efficient digestion processes suitable for converting cellulosic biomass into fuel blends have yet to be developed. In this regard, the most basic requirement associated with converting cellulosic biomass into fuel blends using digestion and other processes is that the energy input needed to bring about the conversion should not be greater than the available energy output of the product fuel blends. This basic requirement leads to a number of secondary issues that collectively present an immense engineering challenge that has not been solved heretofore.

The issues associated with converting cellulosic biomass into fuel blends in an energy- and cost-efficient manner using digestion are not only complex, but they are entirely different than those that are encountered in the digestion processes commonly used in the paper and pulpwood industry. Since the intent of cellulosic biomass digestion in the paper and pulpwood industry is to retain a solid material (e.g., wood pulp), incomplete digestion is usually performed at low temperatures (e.g., less than about 100° C.) for a fairly short period of time. In contrast, digestion processes suitable for converting cellulosic biomass into fuel blends and other materials are ideally configured to maximize yields by solubilizing as much of the original cellulosic biomass charge as possible in a high-throughput manner.

Production of soluble carbohydrates for use in fuel blends and other materials via routine modification of paper and pulpwood digestion processes is not believed to be economically feasible for a number of reasons. Simply running the digestion processes of the paper and pulpwood industry for a longer period of time to produce more soluble carbohydrates is undesirable from a throughput standpoint. Use of digestion promoters such as strong alkalis, strong acids, or sulfites to accelerate the digestion rate can increase process costs and complexity due to post-processing separation steps and the possible need to protect downstream components from these agents. Accelerating the digestion rate by increasing the digestion temperature can actually reduce yields due to thermal degradation of soluble carbohydrates that can occur at elevated digestion temperatures, particularly over extended periods of time. Once produced by digestion, soluble carbohydrates are very reactive and can rapidly degrade to produce caramelans and other heavy ends degradation products, especially under higher temperature conditions, such as above about 150° C. Use of higher digestion temperatures can also be undesirable from an energy efficiency standpoint. Any of these difficulties can defeat the economic viability of fuel blends derived from cellulosic biomass.

One way in which soluble carbohydrates can be protected from thermal degradation is through subjecting them to one or more catalytic reduction reactions, which may include hydrogenation and/or hydrogenolysis reactions. Stabilizing soluble carbohydrates through conducting one or more catalytic reduction reactions may allow digestion of cellulosic biomass to take place at higher temperatures than would otherwise be possible without unduly sacrificing yields. Depending on the reaction conditions and catalyst used, reaction products formed as a result of conducting one or more catalytic reduction reactions on soluble carbohydrates may include triols, diols, monohydric alcohols, or any combination thereof, some of which may also include a residual carbonyl functionality (e.g., an aldehyde or ketone). Such reaction products may be more thermally stable than soluble carbohydrates and are readily transformable into fuel blends and other materials through conducting one or more downstream reforming reactions. In addition, the foregoing types of reaction products are good solvents in which a hydrothermal digestion may be performed, thereby promoting solubilzation of soluble carbohydrates as their reaction products and cellulosic biomass components such as lignin, for example.

Another issue associated with the processing of cellulosic biomass into fuel blends and other materials is created by the need for high conversion percentages of a cellulosic biomass charge into soluble carbohydrates. Specifically, as cellulosic biomass solids are digested, their size gradually decreases to the point that they can become fluidly mobile. As used herein, cellulosic biomass solids that are fluidly mobile, particularly cellulosic biomass solids that are about 3 mm in size or less, will be referred to as “cellulosic biomass fines.” Cellulosic biomass fines can be transported out of a digestion zone of a system for converting cellulosic biomass and into one or more zones where solids are unwanted and can be detrimental. For example, cellulosic biomass fines have the potential to plug catalyst beds, transfer lines, and the like. Furthermore, although small in size, cellulosic biomass fines may represent a non-trivial fraction of the cellulosic biomass charge, and if they are not further converted into soluble carbohydrates, the ability to attain a satisfactory conversion percentage may be impacted. Since the digestion processes of the paper and pulpwood industry are run at relatively low cellulosic biomass conversion percentages, smaller amounts of cellulosic biomass fines are believed to be generated and have a lesser impact on those digestion processes.

In addition to the desired carbohydrates, other materials may be present within cellulosic biomass that can be especially problematic to deal with in an energy- and cost-efficient manner. Sulfur- and/or nitrogen-containing amino acids or other catalyst poisons may be present in cellulosic biomass. If not removed, these catalyst poisons can impact the catalytic reduction reaction(s) used to stabilize soluble carbohydrates, thereby resulting in process downtime for catalyst regeneration and/or replacement and reducing the overall energy efficiency when restarting the process. On the other hand, in-process removal of these catalyst poisons can also impact the energy efficiency of the biomass conversion process, since the ion-exchange processes typically needed to affect their removal are usually conducted at temperatures below those at which soluble carbohydrates are produced by digestion, thereby introducing heat exchange operations that add to design complexity and may increase operational costs. In addition to catalyst poisons, lignin, which is a non-cellulosic biopolymer, may become solubilized in conjunction with the production of soluble carbohydrates. If not addressed in some manner, lignin concentrations may become sufficiently high during biomass conversion that precipitation eventually occurs, thereby resulting in costly system downtime. In the alternative, some lignin may remain unsolubilized, and costly system downtime may eventually be needed to affect its removal.

As evidenced by the foregoing, the efficient conversion of cellulosic biomass into fuel blends is a complex problem that presents immense engineering challenges. The present disclosure addresses these challenges and provides related advantages as well.

### SUMMARY

The present disclosure generally relates to digestion of cellulosic biomass solids, and, more specifically, to biomass conversion systems and methods for use thereof that allow a hydrolysate comprising soluble carbohydrates to be rapidly converted into a more stable reaction product following hydrothermal digestion.

In some embodiments, the present invention provides biomass conversion systems comprising: a hydrothermal digestion unit; a first catalytic reduction reactor unit fluidly coupled to the hydrothermal digestion unit along its height by two or more fluid inlet lines and two or more fluid return lines, the first catalytic reduction reactor unit containing a catalyst capable of activating molecular hydrogen; and a fluid circulation loop comprising the hydrothermal digestion unit and a second catalytic reduction reactor unit that contains a catalyst capable of activating molecular hydrogen.

In some embodiments, the present invention provides biomass conversion systems comprising: a hydrothermal digestion unit; two or more first catalytic reduction reactor units fluidly coupled to the hydrothermal digestion unit along its height, each first catalytic reduction reactor unit being coupled to the hydrothermal digestion unit by a fluid inlet line and a fluid return line and containing a catalyst capable of activating molecular hydrogen; and a fluid circulation loop comprising the hydrothermal digestion unit and a second catalytic reduction reactor unit that contains a catalyst capable of activating molecular hydrogen.

In some embodiments, the present invention provides methods comprising: providing cellulosic biomass solids in a hydrothermal digestion unit; heating the cellulosic biomass solids in the hydrothermal digestion unit to digest at least a portion of the cellulosic biomass solids, thereby forming a hydrolysate comprising soluble carbohydrates within a liquor phase; transferring at least a portion of the liquor phase to one or more first catalytic reduction reactor units fluidly coupled to the hydrothermal digestion unit along its height and at least partially transforming the hydrolysate into a reaction product in the one or more first catalytic reduction reactor units; recirculating at least a portion of the liquor phase from the one or more first catalytic reduction reactor units to the hydrothermal digestion unit; and transferring at least a portion of the liquor phase to a second catalytic reduction reactor unit so as to further transform the soluble carbohydrates into the reaction product.

Other advantages and features of embodiments of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to one having ordinary skill in the art and the benefit of this disclosure.

FIG. 1 shows a schematic of an illustrative biomass conversion system having a catalytic reduction reactor unit fluidly coupled to a hydrothermal digestion unit at various points along its height.

FIG. 2 shows a schematic of an illustrative biomass conversion system having a catalytic reduction reactor unit fluidly coupled to a hydrothermal digestion unit at various points along its height, where the points of fluid coupling are spaced non-uniformly.

FIG. 3 shows a schematic of an illustrative biomass conversion system having multiple catalytic reduction reactor units fluidly coupled to a hydrothermal digestion unit at various points along its height.

### DETAILED DESCRIPTION

The present disclosure generally relates to digestion of cellulosic biomass solids, and, more specifically, to biomass conversion systems and methods for use thereof that allow a hydrolysate comprising soluble carbohydrates to be rapidly converted into a more stable reaction product following hydrothermal digestion.

In the embodiments described herein, the digestion rate of cellulosic biomass may be accelerated in the presence of a digestion solvent at elevated temperatures and pressures that maintain the digestion solvent in a liquid state above its normal boiling point. The more rapid rate of digestion may be desirable from the standpoint of throughput, but soluble carbohydrates may be susceptible to degradation under these conditions, as discussed in more detail hereinafter. In various embodiments, the digestion solvent may contain an organic solvent, particularly an in situ-generated organic solvent, which may provide certain advantages, as described hereinafter.

The present disclosure provides systems and methods that allow cellulosic biomass solids to be efficiently digested to form soluble carbohydrates, which may subsequently be converted through one or more catalytic reduction reactions (e.g., hydrogenolysis and/or hydrogenation) into more stable reaction products comprising oxygenated intermediates that may be further processed into higher hydrocarbons. The higher hydrocarbons may be useful in forming industrial chemicals and transportation fuels (i.e., a biofuel), including, for example, synthetic gasoline, diesel fuels, jet fuels, and the like. As used herein, the term “biofuel” will refer to any transportation fuel formed from a biological source. Such biofuels may also be referred to herein as “fuel blends.” In particular, the systems and methods described herein contain one or more catalytic reduction reactor units that are fluidly coupled in parallel to a hydrothermal digestion unit, thereby allowing a hydrolysate comprising soluble carbohydrates to be efficiently transformed into a more stable reaction product before significant degradation has time to take place.

As used herein, the term “oxygenated intermediates” refers to alcohols, polyols, ketones, aldehydes, and mixtures thereof that are produced from a catalytic reduction reaction (e.g., hydrogenolysis and/or hydrogenation) of soluble carbohydrates. As used herein, the term “higher hydrocarbons” refers to hydrocarbons having an oxygen to carbon ratio less than that of at least one component of the biomass source from which they are produced. As used herein, the term “hydrocarbon” refers to an organic compound comprising primarily hydrogen and carbon, although heteroatoms such as oxygen, nitrogen, sulfur, and/or phosphorus may be present in some embodiments. Thus, the term “hydrocarbon” also encompasses heteroatom-substituted compounds containing carbon, hydrogen, and oxygen, for example.

When a digestion solvent is used at high temperatures and pressures in a hydrothermal digestion, the digestion process may become fairly energy intensive. If the energy input requirements for the digestion process become too great, the economic feasibility of cellulosic biomass as a feedstock material may be jeopardized. That is, if the energy input needed to digest cellulosic biomass becomes too great, processing costs may become higher than the actual value of the product being generated. In order to keep processing costs low, the amount of externally added heat input to the digestion process should be kept as low as possible while achieving as high as possible conversion of the cellulosic biomass into soluble carbohydrates, which can subsequently be transformed into a more stable reaction product. Conversion of soluble carbohydrates into a more stable reaction product is described in more detail hereinafter.

In the embodiments described herein, the soluble carbohydrates and a digestion solvent may be transferred to one or more catalytic reduction reactor units that are fluidly coupled to the hydrothermal digestion unit, such that the soluble carbohydrates may be at least partially transformed into a stabilized reaction product as quickly as possible. Once the soluble carbohydrates have been at least partially transformed into a reaction product, completion of the conversion of the soluble carbohydrates into a reaction product may take place in a second catalytic reduction reactor unit. The described biomass conversion system features can allow a significant quantity of the initially solubilized carbohydrates to be converted into a form that is suitable for subsequent processing into a biofuel, while forming as small as possible an amount of caramelans and other decomposition products in or near the hydrothermal digestion unit.

A leading advantage of the biomass conversion systems described herein is that the systems are configured to rapidly stabilize a significant fraction of the hydrolysate produced therein. In the biomass conversion systems described herein, at least partial stabilization of the hydrolysate may be accomplished by rapidly recirculating the hydrolysate to one or more first catalytic reduction reactor units that are directly coupled (i.e., fluidly coupled) to the hydrothermal digestion unit. The one or more first catalytic reduction reactor units contain molecular hydrogen and a catalyst that is capable of activating molecular hydrogen (also referred to herein as “hydrogen-activating catalysts”). By reacting the hydrolysate in the first catalytic reduction reactor unit(s), an initial, at least partial conversion of the hydrolysate from unstable, soluble carbohydrates into a reaction product comprising more stable oxygenated intermediates can be accomplished. The initial reaction product may then be recirculated to the hydrothermal digestion unit and thereafter be recirculated to the first catalytic reduction reactor unit(s) and/or circulated to a second catalytic reduction reactor unit to form a further transformed reaction product that is more amenable to being transformed into a biofuel. The transformation that takes place in the second catalytic reduction reactor unit may comprise a further reduction in the degree of oxidation of the initial reaction product, an increased conversion of soluble carbohydrates into oxygenated intermediates, or both. The reaction product obtained from the second catalytic reduction reactor unit may be recirculated to the hydrothermal digestion unit and/or be withdrawn for subsequent conversion into a biofuel or other material. By at least partially transforming the soluble carbohydrates into a reaction product before the hydrolysate reaches the second catalytic reduction reactor unit, demands thereon may be lessened, and it may be possible to realize a higher conversion of soluble carbohydrates into the reaction product than would otherwise be possible.

By fluidly coupling the one or more first catalytic reduction reactor units to the hydrothermal digestion unit, excellent heat integration efficiency may be realized. Reaction product that is recirculated to the hydrothermal digestion unit from either catalytic reduction reactor unit may transfer the excess heat produced therein to the hydrothermal digestion unit in order to drive the endothermic digestion process. The input of what would otherwise constitute waste heat may lessen the need to input additional energy into the digestion process, thereby potentially lowering processing costs. Further, since the soluble carbohydrates have been at least partially transformed into a reaction product prior to reaching the second catalytic reduction reactor unit, the demands thereon may be lessened, thereby potentially allowing a smaller reactor unit to be used than would otherwise be possible. In addition, since a high amount of heat integration efficiency may be realized by recirculating reaction product from the first catalytic reduction reactor unit(s), there may be a reduced need to recirculate reaction product from the second catalytic reduction reactor unit in order to maintain an energy efficient process. Thus, lower reaction product recycle ratios may be used, and a greater fraction of the reaction product may be withdrawn from the second catalytic reduction reactor unit for subsequent conversion into a biofuel or other materials. The foregoing factors may also reduce capital and operational costs associated with the biomass conversion systems.

In further regard to heat integration efficiency, the present biomass conversion systems may also be advantageous, since the hydrothermal digestion unit in the systems can be continuously operated at elevated temperatures and pressures, in some embodiments. Continuous, high temperature hydrothermal digestion may be accomplished by configuring the biomass conversion systems such that fresh biomass may be continuously or semi-continuously supplied to the hydrothermal digestion unit while it operates in a pressurized state. That is, the biomass conversion systems may be configured such that biomass may be added to a pressurized hydrothermal digestion unit. Without the ability to introduce fresh biomass to a pressurized hydrothermal digestion unit, depressurization and cooling of the hydrothermal digestion unit may take place during biomass addition, significantly reducing the energy- and cost-efficiency of the conversion process. As used herein, the term “continuous addition” and grammatical equivalents thereof will refer to a process in which biomass is added to a hydrothermal digestion unit in an uninterrupted manner without fully depressurizing the hydrothermal digestion unit. As used herein, the term “semi-continuous addition” and grammatical equivalents thereof will refer to a discontinuous, but as-needed, addition of biomass to a hydrothermal digestion unit without fully depressurizing the hydrothermal digestion unit. A further description of biomass feed mechanisms that may supply biomass to a pressurized hydrothermal digestion unit are described in more detail below.

The biomass conversion systems and associated methods described herein are to be further distinguished from those of the paper and pulpwood industry, where the goal is to harvest partially digested wood pulp, rather than obtaining as high as possible a quantity of soluble carbohydrates, which can be subsequently converted into a reaction product comprising oxygenated intermediates. Since the goal of paper and pulpwood processing is to obtain raw wood pulp, such digestion processes may be conducted at lower temperatures and pressures to remove lower quantities of soluble carbohydrates and non-cellulosic components from the biomass, which can be removed at lower temperatures. In some embodiments described herein, at least about 60% of the cellulosic biomass, on a dry basis, may be digested to produce a hydrolysate comprising soluble carbohydrates. In other embodiments described herein, at least about 90% of the cellulosic biomass, on a dry basis, may be digested to produce a hydrolysate comprising soluble carbohydrates. Given the intent of paper and pulpwood processing, it is anticipated that much lower quantities of soluble carbohydrates are produced in these processes. The design of the present systems may enable high conversion rates by minimizing the formation of degradation products during the processing of biomass, while maintaining long residence times during hydrothermal digestion.

Although fluidly coupling one or more catalytic reduction reactor units directly to a hydrothermal digestion unit may prove advantageous, as described above, such an approach is not without difficulty. Cellulosic biomass, particularly cellulosic biomass fines, may circulate from the hydrothermal digestion unit to the fluidly coupled catalytic reduction reactor unit(s) and result in catalyst plugging therein. This issue can be particularly problematic for the fixed bed catalysts that are commonly used in conjunction with performing catalytic reduction reactions. Although non-fixed bed catalysts, such as fluidized bed catalysts, slurry catalysts, or ebullating bed catalysts, for example, may be used to address the issue of catalyst plugging, such catalysts may be difficult to retain in the catalytic reduction reactor unit(s) due to the fluid circulation used to convey the hydrolysate to and from the catalytic reduction reactor unit(s). Moreover, unless the cellulosic biomass has been previously processed to remove catalyst poisons, catalyst poisoning may also be problematic for some catalysts. Although the cellulosic biomass may be processed to remove catalyst poisons prior to commencing hydrothermal digestion, such operations may increase the associated processing costs.

Unless otherwise specified herein, it is to be understood that use of the terms “biomass” or “cellulosic biomass” in the description herein refers to “cellulosic biomass solids.” Solids may be in any size, shape, or form. The cellulosic biomass solids may be natively present in any of these solid sizes, shapes, or forms, or they may be further processed prior to digestion in the embodiments described herein. The cellulosic biomass solids may also be present in a slurry form in the embodiments described herein.

In practicing the present embodiments, any type of suitable biomass source may be used. Suitable cellulosic biomass sources may include, for example, forestry residues, agricultural residues, herbaceous material, municipal solid wastes, waste and recycled paper, pulp and paper mill residues, and any combination thereof. Thus, in some embodiments, a suitable cellulosic biomass may include, for example, corn stover, straw, bagasse, miscanthus, sorghum residue, switch grass, bamboo, water hyacinth, hardwood, hardwood chips, hardwood pulp, softwood, softwood chips, softwood pulp, and any combination thereof. Leaves, roots, seeds, stalks, husks, and the like may be used as a source of the cellulosic biomass. Common sources of cellulosic biomass may include, for example, agricultural wastes (e.g., corn stalks, straw, seed hulls, sugarcane leavings, nut shells, and the like), wood materials (e.g., wood or bark, sawdust, timber slash, mill scrap, and the like), municipal waste (e.g., waste paper, yard clippings or debris, and the like), and energy crops (e.g., poplars, willows, switch grass, alfalfa, prairie bluestream, corn, soybeans, and the like). The cellulosic biomass may be chosen based upon considerations such as, for example, cellulose and/or hemicellulose content, lignin content, growing time/season, growing location/transportation cost, growing costs, harvesting costs, and the like.

Illustrative carbohydrates that may be present in cellulosic biomass may include, for example, sugars, sugar alcohols, celluloses, lignocelluloses, hemicelluloses, and any combination thereof. Once soluble carbohydrates have been removed from the biomass matrix through a digestion process according to the embodiments described herein, the soluble carbohydrates may be transformed into a reaction product comprising oxygenated intermediates via a catalytic reduction reaction. In some embodiments, the oxygenated intermediates comprising the reaction product may be further transformed into a biofuel using any combination of further hydrogenolysis reactions, hydrogenation reactions, condensation reactions, isomerization reactions, oligomerization reactions, hydrotreating reactions, alkylation reactions, and the like. In some embodiments, at least a portion of the oxygenated intermediates may be recirculated to the hydrothermal digestion unit to comprise at least a portion of the digestion solvent. Recirculation of at least a portion of the oxygenated intermediates to the hydrothermal digestion unit may also be particularly advantageous in terms of heat integration and process efficiency.

In some embodiments, biomass conversion systems described herein can comprise: a hydrothermal digestion unit; a first catalytic reduction reactor unit fluidly coupled to the hydrothermal digestion unit along its height by two or more fluid inlet lines and two or more fluid return lines, the first catalytic reduction reactor unit containing a catalyst capable of activating molecular hydrogen; and a fluid circulation loop comprising the hydrothermal digestion unit and a second catalytic reduction reactor unit that contains a catalyst capable of activating molecular hydrogen.

In some embodiments, biomass conversion systems described herein can comprise: a hydrothermal digestion unit; two or more first catalytic reduction reactor units fluidly coupled to the hydrothermal digestion unit along its height, each first catalytic reduction reactor unit being coupled to the hydrothermal digestion unit by a fluid inlet lines and a fluid return line and containing a catalyst capable of activating molecular hydrogen; and a fluid circulation loop comprising the hydrothermal digestion unit and a second catalytic reduction reactor unit that contains a catalyst capable of activating molecular hydrogen.

In some embodiments, there may be a first catalytic reduction reactor unit coupled to the hydrothermal digestion unit by a plurality of fluid inlet lines and fluid return lines. In some embodiments, there may be an equal number of fluid inlet lines and fluid return lines. In other embodiments, there may be a greater number of fluid inlet lines than fluid return lines. In still other embodiments, there may be a greater number of fluid return lines than fluid inlet lines. As one of ordinary skill in the art will recognize, when the numbers of fluid inlet lines and fluid return lines are unequal, the fluid line type present in smaller number will have a larger size in order to maintain flow balance between the hydrothermal digestion unit and the first catalytic reduction reactor unit. In some embodiments, the fluid inlet lines may all be of the same size, and in other embodiments, at least some of them may be different. In some embodiments, the fluid return lines may all be of the same size, and in other embodiments, at least some of them may be different. In some embodiments, the fluid inlet lines and the fluid return lines may all be of the same size, and in other embodiments, at least some of the fluid lines may be of a different size than the fluid return lines.

In embodiments in which a first catalytic reduction reactor unit is coupled to the hydrothermal digestion unit, there may be one or more fluid inlet lines and one or more fluid return lines connecting the hydrothermal digestion unit and the first catalytic reduction reactor unit. In some embodiments, there may be two or more fluid inlet lines and two or more fluid return lines connecting the hydrothermal digestion unit and the first catalytic reduction reactor unit. In some embodiments, there may be between about 3 and about 10 pairs of fluid inlet lines and fluid return lines connecting the hydrothermal digestion unit and the first catalytic reduction reactor unit.

In some embodiments, the fluid inlet lines and the fluid return lines may be distributed uniformly along the height of the hydrothermal digestion unit. A uniform distribution of the fluid inlet lines and the fluid return lines can comprise, for example, an even spacing of the lines along the height of the hydrothermal digestion unit or an even spacing of the lines along a height of a region of the hydrothermal digestion unit. In other embodiments, the fluid inlet lines and the fluid return lines may be distributed non-uniformly along the height of the hydrothermal digestion unit. A non-uniform distribution of fluid inlet lines and fluid return lines can comprise, for example, a non-even spacing of the lines along the height of the hydrothermal digestion unit or a non-even spacing of the lines along a height of a region of the hydrothermal digestion unit. In some embodiments, the fluid inlet lines may be configured to remove hydrolysate from different regions of the hydrothermal digestion unit, where the regions may have varying thermal profiles. For example, in some embodiments, the fluid inlet lines may be configured to transfer hydrolysate to the first catalytic reduction reactor unit from a thermal region of the hydrothermal digestion unit where decomposition is more likely to take place (e.g., a higher temperature region), and the fluid return lines may be configured to return the reaction product to the hydrothermal digestion unit in the same thermal region or a different thermal region. In some embodiments, the fluid return lines may return the reaction product to a lower temperature thermal region compared to a higher temperature thermal region where the fluid inlet lines removed the hydrolysate.

In some embodiments, two or more first catalytic reduction reactor units may be coupled to the hydrothermal digestion unit, each first catalytic reduction reactor unit being coupled to the hydrothermal digestion unit along its height by a fluid inlet line and a fluid return line. Such a configuration may be used as an alternative to providing multiple fluid connections to a single first catalytic reduction reactor unit, thereby achieving a like result. In addition, use of multiple second catalytic reduction reactor units in lieu of a larger, single first catalytic reduction reactor unit may more readily facilitate the continuous processing of biomass using the biomass conversion systems. Specifically, during operation of the biomass conversion systems, it may be necessary to regenerate or replace the catalyst in the first catalytic reduction reactor unit(s). When only a single first catalytic reduction reactor unit is used, process downtime and startup may reduce the energy and cost efficiency of the conversion process when the system is taken offline to replace or regenerate the catalyst. In contrast, when multiple first catalytic reduction reactor units are used, one or more first catalytic reduction reactor units may be taken offline at a time, and the system can be allowed to maintain continuous operation with the remaining first catalytic reduction reactor units.

In some embodiments, there may be two or more first catalytic reduction reactor units coupled to the hydrothermal digestion unit. In some embodiments, there may be about 3 to about 10 first catalytic reduction reactor units coupled to the hydrothermal digestion unit along its height. In some embodiments, the first catalytic reduction reactor units may be distributed non-uniformly along the height of the hydrothermal digestion unit. Reasons for including a non-uniform distribution can include those described above in regard to the non-uniform distribution of fluid inlet lines and fluid outlet lines connecting the hydrothermal digestion unit and a single first catalytic reduction reactor unit. In other embodiments, the first catalytic reduction reactor units may be distributed uniformly along the height of the hydrothermal digestion unit.

In embodiments in which multiple first catalytic reduction reactor units are present, each first catalytic reduction reactor unit may have a fluid inlet line and a fluid return line connecting the hydrothermal digestion unit and the catalytic reduction reactor unit. In some embodiments, at least some of the first catalytic reduction reactor units may have more than one fluid inlet line, more than one fluid outlet line, or both.

In some embodiments, the first catalytic reduction reactor unit(s), the second catalytic reduction reactor unit, or both may contain a poison-tolerant catalyst. Use of a poison-tolerant catalyst may be desirable when the hydrolysate is not purified before passing to the catalytic reduction reactor units and/or if the catalyst poisons are not removed from the cellulosic biomass solids prior to commencing hydrothermal digestion. In some cases, the hydrolysate may not be purified before undergoing the catalytic reduction reaction in order to maintain heat transfer integrity within the biomass conversion process. Use of a poison-tolerant catalyst may avoid the disadvantages associated with catalyst regeneration and replacement, particularly when a single first catalytic reduction reactor unit having multiple fluid inlets and outlets is use. As used herein, a “poison-tolerant catalyst” is defined as a catalyst that is capable of activating molecular hydrogen without needing to be regenerated or replaced due to low catalytic activity for at least about 12 hours of continuous operation.

In some embodiments, suitable poison-tolerant catalysts may include, for example, a sulfided catalyst. Sulfided catalysts suitable for activating molecular hydrogen are described in commonly owned United States patent application Ser. No. 13/495,785, filed Jun. 13, 2012, and 61/553,591, filed Oct. 31, 2011, each of which is incorporated herein by reference in its entirety. Sulfiding may take place by treating a catalyst with hydrogen sulfide or other sulfiding agent, optionally while the catalyst is deposited on a solid support. In more particular embodiments, the poison-tolerant catalyst may comprise a sulfided cobalt-molybdate catalyst. We have found that sulfided cobalt-molybdate catalysts may give high yields of oxygenated intermediates while not forming an excess amount of C₂-C₄ alkanes. The oxygenated intermediates formed may be readily separated from water via flash vaporization or liquid-liquid phase separation, and undergo condensation-oligomerization reactions in separate steps over an acid or base catalyst, to product liquid biofuels in the gasoline, jet, or diesel range.

In alternative embodiments, a regenerable catalyst may be used in the first catalytic reduction reactor unit(s), the second catalytic reduction reactor unit, or both. As used herein, a “regenerable catalyst” may have at least some of its catalytic activity restored through regeneration, even when poisoned with nitrogen compound impurities, sulfur compound impurities, or any combination thereof. Ideally, such regenerable catalysts should be regenerable with a minimal amount of process downtime. In some embodiments, sulfided catalysts may also be regenerable.

In some embodiments, the catalyst capable of activating molecular hydrogen located within the first catalytic reduction reactor unit(s) may comprise a non-plugging catalyst that is tolerant to the presence of at least some solid materials. Specifically, in some embodiments, the catalyst in the first catalytic reduction reactor unit(s) may comprise a catalyst that does not become substantially plugged by the introduction of cellulosic biomass solids or cellulosic biomass fines produced therefrom. Further description regarding cellulosic biomass fines is provided hereinbelow. Such catalysts desirably have high void fractions such that solid materials are not retained by the catalysts and pass directly therethrough. As used herein, the term “void fraction” refers to the internal volume of a reactor accessible to a liquid phase or a gas phase in the presence of a catalyst, usually expressed as a fraction of the total reactor volume. In some embodiments, the first catalytic reduction reactor unit(s) may comprise a fixed bed catalyst having a void fraction of at least about 20%. In other embodiments, the fixed bed catalyst may have a void fraction of at least about 30%, or at least about 40%, or at least about 50%, or at least about 60%, or at least about 70%. Suitable catalyst shapes producing high void fractions will be familiar to one having ordinary skill in the art. A review of catalyst shapes and their impact on void fraction is provided by S. Afandizadeh and E. A. Foumeny, Applied Thermal Engineering 21:2001 pp. 669-682, which is incorporated herein by reference in its entirety. In some embodiments, suitable non-plugging catalysts may comprise a shape such as, for example, a catalytic monolith, a cylinder or ring, a minilith, a wagon wheel, a saddle, or the like. In some embodiments, suitable non-plugging catalysts may have a hole protruding through the catalyst particle, such that it has a higher effective surface area and produces a higher void fraction. In some or other embodiments, suitable non-plugging catalysts may comprise a catalytic coating on a surface such as, for example, a protruded metal packing. In some embodiments, the non-plugging catalyst may comprise a poison-tolerant catalyst. In other embodiments, the non-plugging catalyst may comprise a regenerable catalyst.

In some embodiments, the catalytic reduction reactions carried out in the catalytic reduction reactor units may be hydrogenolysis reactions. A detailed description of hydrogenolysis reactions is included hereinbelow.

In general, the catalytic reduction reactor units used in accordance with the embodiments described herein may be of any suitable type or configuration. In some embodiments, at least one of the catalytic reduction reactor units may comprise a fixed bed catalytic reactor such as, for example, a trickle bed catalytic reactor. For example, in some embodiments, the first catalytic reduction reactor unit may comprise a fixed bed catalytic reactor. Other suitable catalytic reduction reactor configurations may include, for example, slurry bed catalytic reactors with filtration, loop reactors, upflow gas-liquid reactors, ebullating bed reactors, fluidized bed reactors, and the like. In some embodiments, the second catalytic reduction reactor unit may comprise a reactor configuration such as, for example, a fixed bed catalytic reactor, a slurry bed catalytic reactor with filtration, a loop reactor, an upflow gas-liquid reactor, an ebullating bed reactor, a fluidized bed reactor, or the like.

In some embodiments, the fluid circulation loop may be configured to establish countercurrent flow in the hydrothermal digestion unit. As used herein, the term “countercurrent flow” refers to the direction a reaction product enters the hydrothermal digestion unit relative to the direction in which biomass is introduced to the digestion unit. Other flow configurations such as, for example, co-current flow may also be used, if desired.

In some embodiments, there may be a solids separation mechanism within at least some of the fluid inlet lines, within the fluid circulation loop, or both. Solids separation mechanisms may include any separation technique known in the art including filters, centrifugal force- or centrifugal force-based separation mechanisms (e.g., hydroclones), settling tanks, centrifuges, and the like. Suitable filters may include, for example, surface filters and depth filters. Surface filters may include, for example, filter papers, membranes, porous solid media, and the like. Depth filters may include, for example, a column or plug of porous media designed to trap solids within its core structure. In some embodiments, the biomass conversion systems may include a solids separation mechanism in fluid communication with at least some of the fluid inlet lines between the hydrothermal digestion unit and the first catalytic reduction reactor unit. In some embodiments, the biomass conversion systems may include a solids separation mechanism in fluid communication with the fluid circulation loop between an outlet of the hydrothermal digestion unit and an inlet of the second catalytic reduction reactor unit.

In more particular embodiments, the optional solids separation mechanism in at least some of the fluid inlet lines may comprise a hydroclone. When solids separation does take place in this location, a hydroclone may be an especially suitable solids separation mechanism, since it may not be necessary for exhaustive removal of all solids to take place before the hydrolysate enters the first catalytic reduction reactor unit(s). Particularly when a catalyst having a high void fraction (e.g., a non-plugging catalyst) is used in the first catalytic reduction reactor unit(s), a certain level of transported solids may be tolerable. In addition, hydroclones allow rapid solids separation to take place. Thus, use of a hydroclone within the fluid inlet lines may be particularly favorable to maintain rapid fluid transport between the hydrothermal digestion unit and the first catalytic reduction reactor unit(s), thereby maintaining good heat integration and allowing the soluble carbohydrates of the hydrolysate to be quickly stabilized by forming an oxygenated reaction product. Although a hydroclone may be particularly suitable for use within the fluid inlet line(s), it is to be recognized that any appropriate type of solids separation mechanism may be used, if needed, in various configurations of the biomass conversion systems. In some embodiments, each fluid inlet line connecting the hydrothermal digestion unit and the first catalytic reduction reactor unit(s) may contain a solids separation mechanism. In other embodiments, only a portion of the fluid inlet lines connecting the hydrothermal digestion unit and the first catalytic reduction reactor unit(s) may contain a solids separation mechanism. In still other embodiments, the fluid inlet lines connecting the hydrothermal digestion unit and the first catalytic reduction reactor unit(s) may lack a solids separation mechanism.

Within the fluid circulation loop, there may be more tolerance for longer fluid residence times (i.e., lower recycle ratios), and greater levity may be exercised in choosing a solids separation mechanism for this location. Accordingly, depending on operational constraints, one or more filters, hydroclones, settling tanks, centrifuges and/or the like may be used within the fluid circulation loop. In some embodiments, two or more filters may be used within the fluid circulation loop, where at least one of the filters may be backflushed to the hydrothermal digestion unit while forward fluid flow continues through at least some of the remaining filters and onward to the second catalytic reduction reactor unit. In some embodiments, one or more hydroclones may be used within the fluid circulation loop. Use of filters and hydroclones within the fluid circulation loop are described in commonly owned United States Patent Applications 61/576,623 and 61/576,717, each filed on Dec. 16, 2011, and incorporated herein by reference in its entirety.

In some embodiments, the biomass conversion systems may further comprise a fluid transfer line that establishes fluid communication between the first catalytic reduction reactor unit(s) and the fluid circulation loop. Use of a fluid transfer line in this location may allow a reaction product produced in the first catalytic reaction unit(s) to be directly transported to the fluid circulation loop and onward to the second catalytic reduction reactor unit, but without first travelling through the hydrothermal digestion unit. Reasons why one would desire to deliver the reaction product directly to the fluid circulation loop, as opposed to returning it to the hydrothermal digestion unit, may include, for example, thermal regulation of the hydrothermal digestion unit, maintaining flow balance, and the like. In configurations where there are multiple first catalytic reduction reactor units, each first catalytic reduction reactor unit may contain a fluid transfer line in some embodiments. In other embodiments, some of the first catalytic reduction reactor units may contain a fluid transfer line and some may lack a fluid transfer line.

In some embodiments, the hydrothermal digestion unit may be, for example, a pressure vessel of carbon steel, stainless steel, or a similar alloy. In some embodiments, a single hydrothermal digestion unit may be used. In other embodiments, multiple hydrothermal digestion units operating in series, parallel or any combination thereof may be used. In some embodiments, digestion may be conducted in a pressurized hydrothermal digestion unit operating continuously. However, in other embodiments, digestion may be conducted in batch mode. Suitable hydrothermal digestion units may include, for example, the “PANDIA™ Digester” (Voest-Alpine Industrienlagenbau GmbH, Linz, Austria), the “DEFIBRATOR Digester” (Sunds Defibrator AB Corporation, Stockholm, Sweden), the M&D (Messing & Durkee) digester (Bauer Brothers Company, Springfield, Ohio, USA) and the KAMYR Digester (Andritz Inc., Glens Falls, N.Y., USA). In some embodiments, the biomass may be at least partially immersed in the hydrothermal digestion unit. In other embodiments, the hydrothermal digestion unit may be operated as a trickle bed or pile-type hydrothermal digestion unit. Fluidized bed and stirred contact hydrothermal digestion units may also be used in some embodiments. Suitable hydrothermal digestion unit designs may include, for example, co-current, countercurrent, stirred contact, or fluidized bed hydrothermal digestion units.

In general, digestion may be conducted in a liquor phase. In some embodiments, the liquor phase may comprise a digestion solvent that comprises water. In some embodiments, the liquor phase may further comprise an organic solvent. In some embodiments, the organic solvent may comprise oxygenated intermediates produced from a catalytic reduction reaction of soluble carbohydrates. For example, in some embodiments, a digestion solvent may comprise oxygenated intermediates produced by a hydrogenolysis reaction or other catalytic reduction reaction of soluble carbohydrates. In some embodiments, the oxygenated intermediates may include those produced in the first catalytic reduction reactor unit(s) and the second catalytic reduction reactor unit. In some embodiments, bio-ethanol may be added to water as a startup digestion solvent, with a solvent comprising oxygenated intermediates being produced thereafter and introduced to the hydrothermal digestion unit. Any other organic solvent that is miscible with water may also be used as a startup digestion solvent, if desired. In general, a sufficient amount of liquor phase is present in the digestion process such that the biomass surface remains wetted. The amount of liquor phase may be further chosen to maintain a sufficiently high concentration of soluble carbohydrates to attain a desirably high reaction rate during catalytic reduction, but not so high such that degradation becomes problematic. In some embodiments, the concentration of soluble carbohydrates may be kept below about 5% by weight of the liquor phase to minimize degradation. However, it is to be recognized that higher concentrations may be used in some embodiments. In some embodiments, organic acids such as, for example, acetic acid, oxalic acid, salicylic acid, or acetylsalicylic acid may be included in the liquor phase as an acid promoter of the digestion process.

In some embodiments, prior to digestion, the cellulosic biomass may be washed and/or reduced in size (e.g., by chopping, crushing, debarking, and the like) to achieve a desired size and quality for being digested. The operations may remove substances that interfere with further chemical transformation of soluble carbohydrates and/or improve the penetration of digestion solvent into the biomass. In some embodiments, washing may occur within the hydrothermal digestion unit prior to pressurization. In other embodiments, washing may occur before the biomass is placed in the hydrothermal digestion unit.

In some embodiments, the digestion solvent may comprise oxygenated intermediates of an in situ generated organic solvent. As used herein, the term “in situ generated organic solvent” refers to the reaction product produced from a catalytic reduction reaction of soluble carbohydrates, where the catalytic reduction reaction takes place in one or more catalytic reduction reactor units coupled to the biomass conversion system. In some embodiments, the in situ generated organic solvent may comprise at least one alcohol, ketone, or polyol. In alternative embodiments, the digestion solvent may be at least partially supplied from an external source. For example, in an embodiment, bio-ethanol may be used to supplement the in situ-generated organic solvent. Other water-miscible organic solvents may be used as well. In some embodiments, the digestion solvent may be separated, stored, or selectively injected into the hydrothermal digestion unit so as to maintain a desired concentration of soluble carbohydrates or to provide temperature regulation in the hydrothermal digestion unit.

In some embodiments, digestion may take place over a period of time at elevated temperatures and pressures. In some embodiments, digestion may take place at a temperature ranging between about 100° C. to about 250° C. for a period of time. In some embodiments, the period of time may range between about 0.25 hours and about 24 hours. In some embodiments, the digestion to produce soluble carbohydrates may occur at a pressure ranging between about 1 bar (absolute) and about 100 bar.

In various embodiments, suitable biomass digestion techniques may include, for example, acid digestion, alkaline digestion, enzymatic digestion, and digestion using hot-compressed water.

Various factors may influence the digestion process. In some embodiments, hemicellulose may be extracted from the biomass at temperatures below about 160° C. to produce a predominantly C₅ carbohydrate fraction. At increasing temperatures, this C₅ carbohydrate fraction may be thermally degraded. It may therefore be advantageous to convert the C₅ and/or C₆ carbohydrates and/or other sugar intermediates into more stable intermediates such as sugar alcohols, alcohols, and polyols, for example. By reacting the soluble carbohydrates in the catalytic reduction reactor unit(s) and recycling at least a portion of the reaction product to the hydrothermal digestion unit, the concentration of oxygenated intermediates may be increased to commercially viable concentrations while the concentration of soluble carbohydrates is kept low.

In some embodiments, cellulose digestion may begin above about 160° C., with solubilization becoming complete at temperatures around about 190° C., aided by organic acids (e.g., carboxylic acids) formed from partial degradation of carbohydrate components. Some lignins may be solubilized before cellulose, while other lignins may persist to higher temperatures. These lignins may optionally be removed at a later time. The digestion temperature may be chosen so that carbohydrates are solubilized while limiting the formation of degradation products. In some embodiments, the digestion process may be conducted in stages, with a first stage being conducted at about 160° C. or below to solubilize and convert hemicellulose into a reaction product, and with a second stage being conducted at about 160° C. or above to solubilize and convert cellulose into a reaction product.

In some embodiments, a plurality of hydrothermal digestion units may be used. In some embodiments, the biomass may first be introduced into a hydrothermal digestion unit operating at about 160° C. or below to solubilize C₅ carbohydrates and some lignin without substantially degrading these products. The remaining biomass may then exit the first hydrothermal digestion unit and pass to a second hydrothermal digestion unit. The second hydrothermal digestion unit may be used to solubilize C₆ carbohydrates at a higher temperature. In some embodiments, a series of hydrothermal digestion units may be used with an increasing temperature profile, so that a desired carbohydrate fraction is solubilized in each.

In some embodiments, the biomass conversion systems may further comprise a biomass feed mechanism that is operatively coupled to the hydrothermal digestion unit and allows cellulosic biomass solids to be continuously or semi-continuously added to the hydrothermal digestion unit without the hydrothermal digestion unit being fully depressurized. In some embodiments, the biomass feed mechanism may comprise a pressurization zone. Cellulosic biomass may be pressurized using the pressurization zone and then introduced to the hydrothermal digestion unit in a continuous or semi-continuous manner without fully depressurizing the digestion unit. Pressurizing the cellulosic biomass prior to its introduction to the hydrothermal digestion unit may allow the digestion unit to remain pressurized and operating continuously during biomass addition. Additional benefits of pressurizing the cellulosic biomass prior to hydrothermal digestion are also discussed hereinafter.

In some embodiments, the biomass conversion systems may further comprise a loading mechanism that is operatively connected to the pressurization zone. Any type of loading mechanism capable of dropping or transporting cellulosic biomass may be used in the present embodiments. Suitable loading mechanisms may include, for example, conveyer belts, vibrational tube conveyers, screw feeders or conveyers, bin dispensers, and the like. It is to be recognized that in some embodiments, the loading mechanism may be omitted. For example, in some embodiments, addition of cellulosic biomass to the pressurization zone may take place manually. In some embodiments, the cellulosic biomass may be provided and introduced to the pressurization zone at the same time. That is, a loading mechanism need not necessarily be used.

During the operation of the biomass conversion systems, the pressurization zone may cycle between a pressurized state and an at least partially depressurized state, while the hydrothermal digestion unit may remain continuously operating in a pressurized state. While the pressurization zone is at least partially depressurized, cellulosic biomass may be introduced to the pressurization zone via the loading mechanism, if used. Suitable types of pressurization zones and operation thereof are described in commonly owned U.S. patent application Ser. Nos. 13/332,322 and 13/332,329, each filed on Dec. 20, 2011 and incorporated herein by reference in its entirety.

In some embodiments, the cellulosic biomass within the pressurization zone may be pressurized, at least in part, by introducing at least a portion of the liquor phase in the hydrothermal digestion unit to the pressurization zone. In some or other embodiments, the cellulosic biomass within the pressurization zone may be pressurized, at least in part, by introducing a gas to the pressurization zone. In some embodiments, the liquor phase may comprise an organic solvent, which is generated as a reaction product of the catalytic reduction reactor unit(s). In other embodiments, an external solvent may be used to pressurize the pressurization zone.

At least two benefits may be realized by pressurizing the biomass in the presence of the liquor phase from the hydrothermal digestion unit. First, pressurizing the biomass in the presence of the liquor phase may cause the digestion solvent to infiltrate the biomass, which may cause the biomass to sink in the digestion solvent once introduced to the hydrothermal digestion unit. Further, by adding hot liquor phase to the biomass in the pressurization zone, less energy may need to be input to bring the biomass up to temperature once introduced to the hydrothermal digestion unit. Both of these features may improve the efficiency of the digestion process.

In some embodiments, the present biomass conversion systems may further comprise a phase separation mechanism in fluid communication with an outlet of the second catalytic reduction reactor unit. Suitable phase separation mechanisms may include for, example, phase separators, solvent stripping columns, extractors, filters, distillations, and the like. In some embodiments, azeotropic distillation may be conducted. In some embodiments, the phase separation mechanism may be used to separate an aqueous phase and an organic phase of the reaction product. In some embodiments, at least a portion of the aqueous phase may be recirculated to the hydrothermal digestion unit. In some or other embodiments, at least a portion of the organic phase may be removed from the fluid circulation loop and subsequently be converted into a biofuel, as described hereinafter. In some embodiments, at least a portion of the organic phase may be recirculated to the hydrothermal digestion unit.

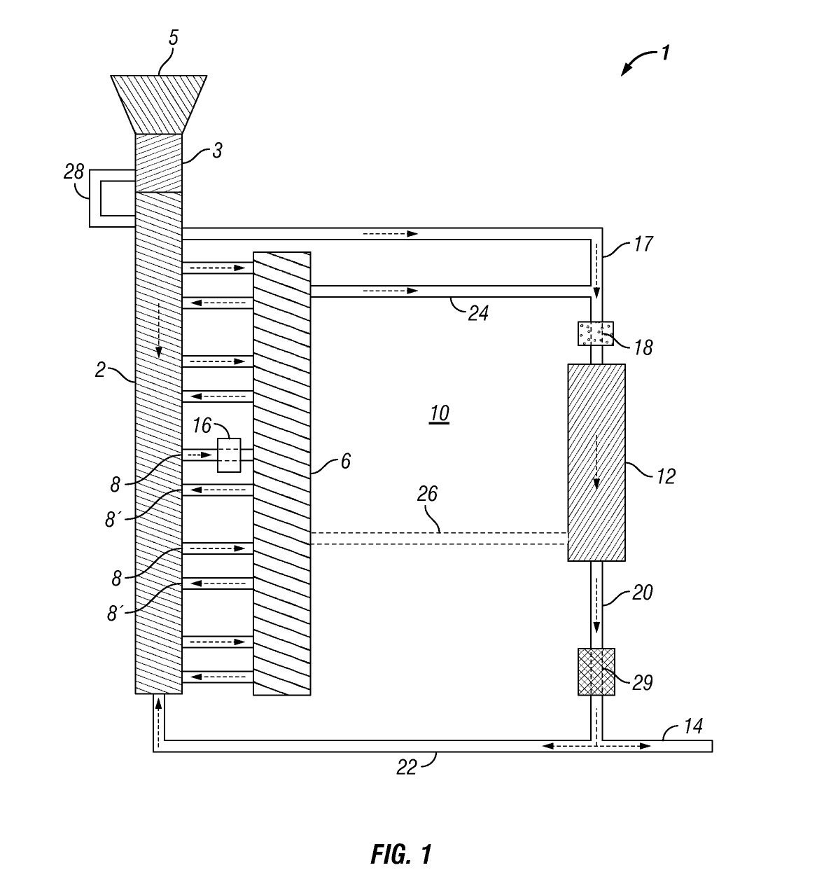

The biomass conversion systems of the foregoing description will now be further described with reference to the drawings. FIG. 1 shows a schematic of an illustrative biomass conversion system having a catalytic reduction reactor unit fluidly coupled to a hydrothermal digestion unit at various points along its height. Biomass conversion system 1 contains hydrothermal digestion unit 2, which is coupled to first catalytic reduction reactor unit 6 via fluid inlet lines 8 and fluid return lines 8′. Although FIG. 1 has depicted five pairs of fluid inlet lines 8 and fluid return lines 8′, it is to be recognized that any number can be present.

Hydrothermal digestion unit 2 is in fluid communication with second catalytic reduction reactor unit 12 via fluid circulation loop 10. As drawn, fluid circulation loop 10 is configured to establish countercurrent flow in hydrothermal digestion unit 2. Other types of fluid connections to hydrothermal digestion unit 2 are also possible. The direction of biomass introduction into hydrothermal digestion unit 2 and flow of bulk biomass therein is indicated by a dashed arrow. Hydrogen feed lines to first catalytic reduction reactor unit 6 and to second catalytic reduction reactor unit 12 have not been depicted for purposes of clarity.

Biomass conversion system 1 also contains reaction product takeoff line 14, which is in fluid communication with fluid circulation loop 10 after the outlet of second catalytic reduction reactor unit 12. During operation of the biomass conversion systems, a reaction product may exit second catalytic reduction reactor unit 12 via line 20. Reaction product may then be removed from fluid circulation loop 10 by reaction product takeoff line 14 for subsequent further transformation into a biofuel, or the reaction product may be returned to hydrothermal digestion unit 2 via line 22, where it may serve as a digestion solvent or undergo further conversion, for example.

Various optional elements may be present in biomass conversion system 1. As described above, in some embodiments, solids separation mechanism 16, such as a hydroclone, for example, may be located within any of fluid inlet lines 8. As drawn, FIG. 1 has depicted solids separation mechanism 16 within only one fluid inlet line 8, however, it is to be recognized that any number of the fluid inlet lines 8 may contain solids separation mechanism 16, if desired. As also described above, solids separation mechanism 18 may also be present in fluid circulation loop 10. As depicted, solids separation mechanism 18 is located before an inlet of second catalytic reduction reactor unit 12, such that entry of particulate matter thereto is inhibited. In some embodiments, solids separation mechanism 18 may comprise two or more reciprocating filters, or a filter array, where some of the filters can maintain fluid flow in the forward direction, while at least one filter is being backflushed or otherwise regenerated. In some embodiments, solids separation mechanism 18 may comprise a hydroclone.

Another optional element of biomass conversion system 1 is fluid bypass line 24, which establishes fluid communication between first catalytic reduction reactor unit 6 and fluid circulation loop 10. Fluid bypass line 24 can allow a reaction product to be directly transported from first catalytic reduction reactor unit 6 directly to fluid circulation loop 10 without directly travelling through hydrothermal digestion unit 2. As drawn, fluid bypass line 24 establishes fluid communication to fluid circulation loop 10 at line 17. However, it is to be recognized that fluid bypass line 24 may establish fluid communication at any point in fluid circulation loop 10, including to second catalytic reduction reactor unit 12, if desired. Although FIG. 1 has shown only one fluid bypass line 24, it is to be recognized that any number can be present.

Still another optional element of biomass conversion system 1 is gas recycle line 26 that allows a gas to travel between first catalytic reduction reactor unit 6 and second catalytic reduction reactor unit 12. Specifically, gas recycle line 26 can allow unreacted hydrogen gas to travel from first catalytic reduction reactor unit 6 to second catalytic reduction reactor unit 12, or vice versa, during operation of biomass conversion system 1. The opportunity to recycle the hydrogen gas can reduce the overall hydrogen requirements of the biomass conversion process. Hydrogen gas inlet lines to first catalytic reduction reactor unit 6 and second catalytic reduction reactor unit 12 have been omitted in FIG. 1 for purposes of clarity. In some embodiments, the hydrogen gas may be generated in situ elsewhere in the biomass conversion systems.

Still another optional element that may be included in biomass conversion system 1 is phase separation mechanism 29, which is in fluid communication with line 20. As described above, phase separation mechanism 29 may be used to at least partially separate the organic phase of the reaction product from an aqueous phase.

Optional line 28 may be used to transfer liquor phase from hydrothermal digestion unit 2. For example, line 28 may be used to transfer liquor phase from hydrothermal digestion unit 2 to at least partially pressurize pressurization zone 3. Cellulosic biomass solids may be supplied to pressurization zone 3 from loading mechanism 5 before pressurizing and introducing the pressurized biomass to hydrothermal digestion unit 2. Pressurization zone 3 can be used to step up the pressure of the biomass solids introduced from loading mechanism 5, such that hydrothermal digestion unit 2 does not have to be fully depressurized during biomass solids addition, thereby allowing the digestion process to proceed in a substantially uninterrupted manner.

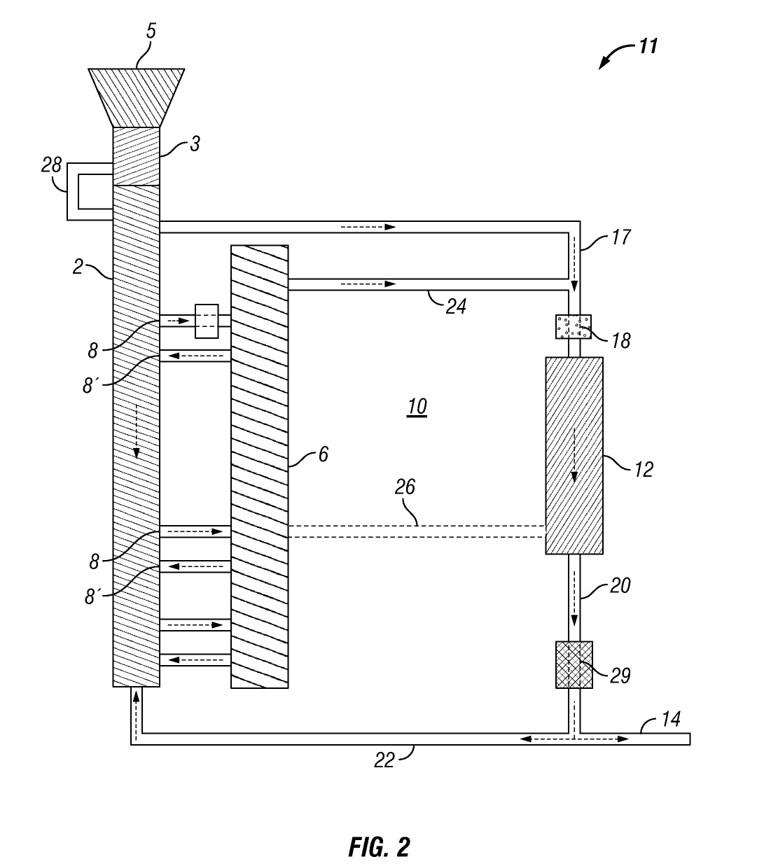

Although FIG. 1 has depicted a substantially regular spacing of fluid inlet lines 8 and fluid return lines 8′ along the height of hydrothermal digestion unit 2, it is to be recognized that fluid inlet lines 8 and fluid return lines 8′ may be spaced non-uniformly along the height of hydrothermal digestion unit 2, as described hereinabove. FIG. 2 shows a schematic of an illustrative biomass conversion system 11 having a catalytic reduction reactor unit fluidly coupled to a hydrothermal digestion unit at various points along its height, where the points of fluid coupling are spaced non-uniformly. In addition, FIG. 2 has depicted a schematic of an illustrative biomass conversion system 21 with a reduced number of fluid inlet lines 8 and fluid return lines 8′ relative to FIG. 1. The remaining reference characters depicted in FIG. 2 are substantially the same as depicted and described in FIG. 1 and will not be described again in detail.

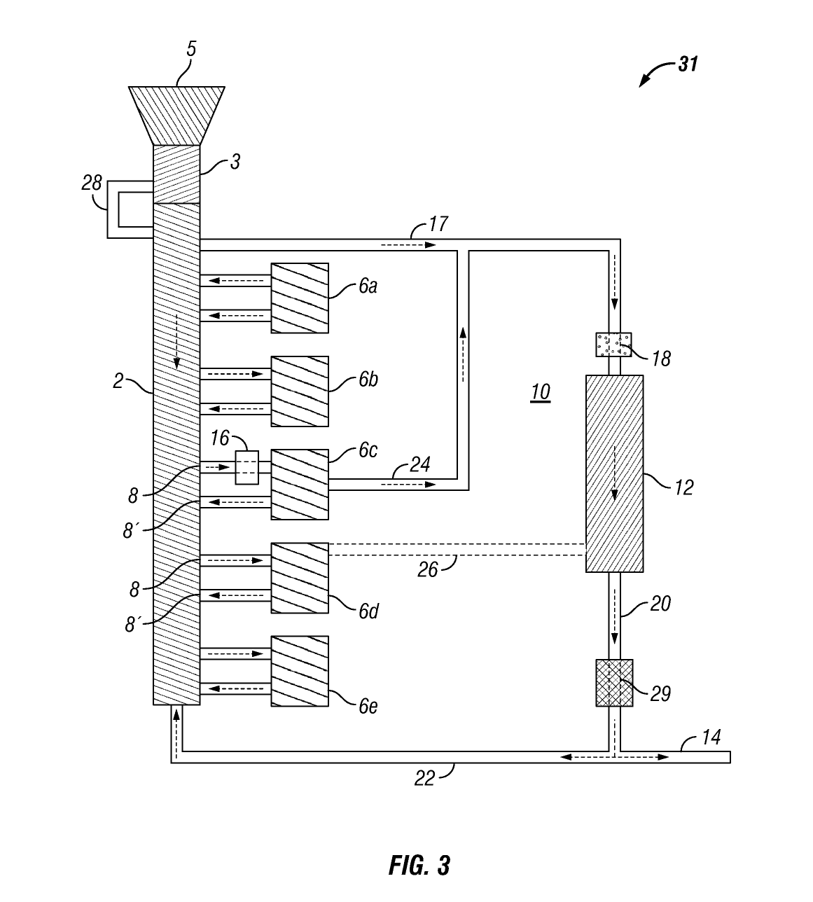

As described above, in some embodiments, one or more first catalytic reduction reactor units may be coupled to the hydrothermal digestion unit along its height, as opposed to a single first catalytic reduction reactor unit coupled at multiple points with fluid inlet lines and fluid outlet lines, as depicted in FIGS. 1 and 2. FIG. 3 shows a schematic of an illustrative biomass conversion system 31 having multiple catalytic reduction reactor units fluidly coupled to a hydrothermal digestion unit at various points along its height. As depicted in FIG. 3, five first catalytic reduction reactor units 6a-6e have replaced the single first catalytic reduction reactor unit 6 of FIGS. 1 and 2. The remaining reference characters in FIG. 3 are substantially the same as depicted and described in FIG. 1 and will not be described again in detail. Although FIG. 3 has depicted five first catalytic reduction reactor units coupled to hydrothermal digestion unit 2, it is to be recognized that any configuration having two or more parallel first catalytic reduction reactor units may be used. Furthermore, optional elements, such as solids separation mechanism 16 and gas recycle line 26, when present, may be used in conjunction with a single first catalytic reduction reactor unit, as depicted, or any number of the other first catalytic reduction reactor units. In addition, although first catalytic reduction reactor units 6a-6e have each been depicted with a single fluid inlet line 8 and a single fluid return line 8′, more than one of either may be used, if desired. As in FIG. 1, hydrogen gas inlet lines to catalytic reduction reactor units 6a-6e and 12 of FIG. 3 have been omitted for purposes of clarity.

In some embodiments, methods for processing cellulosic biomass solids are described herein. In some embodiments, the methods can comprise: providing cellulosic biomass solids in a hydrothermal digestion unit; heating the cellulosic biomass solids in the hydrothermal digestion unit to digest at least a portion of the cellulosic biomass solids, thereby forming a hydrolysate comprising soluble carbohydrates within a liquor phase; transferring at least a portion of the hydrolysate to one or more first catalytic reduction reactor units fluidly coupled to the hydrothermal digestion unit along its height and at least partially transforming the hydrolysate into a reaction product in the one or more first catalytic reduction reactor units; recirculating at least a portion of the liquor phase from the one or more first catalytic reduction reactor units to the hydrothermal digestion unit; and transferring at least a portion of the liquor phase to a second catalytic reduction reactor unit so as to further transform the soluble carbohydrates into the reaction product.

In some embodiments, methods for processing cellulosic biomass solids can comprise: providing a biomass conversion system comprising: a hydrothermal digestion unit; one or more first catalytic reduction reactor units fluidly coupled to the hydrothermal digestion unit along its height, each first catalytic reduction reactor unit being coupled to the hydrothermal digestion unit by a fluid inlet line and a fluid return line and containing a catalyst capable of activating molecular hydrogen; and a fluid circulation loop comprising the hydrothermal digestion unit and a second catalytic reduction reactor unit that contains a catalyst capable of activating molecular hydrogen; providing cellulosic biomass solids in the hydrothermal digestion unit; heating the cellulosic biomass solids in the hydrothermal digestion unit to digest at least a portion of the cellulosic biomass solids, thereby forming a hydrolysate comprising soluble carbohydrates within a liquor phase; transferring at least a portion of the liquor phase from the hydrothermal digestion unit to the one or more first catalytic reduction reactor units so as to form a reaction product therein; recirculating at least a portion of the liquor phase from the one or more first catalytic reduction reactor units to the hydrothermal digestion unit; and transferring at least a portion of the liquor phase to a second catalytic reduction reactor unit so as to further transform the soluble carbohydrates into the reaction product.

In some embodiments, the methods may further comprise performing a solids separation while transferring the liquor phase between the hydrothermal digestion unit and the one or more first catalytic reduction reactor units. In some embodiments, the methods may further comprise performing a solids separation while transferring the liquor phase between the hydrothermal digestion unit and the second catalytic reduction reactor unit. Solids separation techniques may take place though any of the methodologies set forth hereinabove. In some embodiments, the methods may further comprise returning the separated solids to the hydrothermal digestion unit. Solids separated may include cellulosic biomass solids, cellulosic biomass fines, and the like.

In some embodiments, the methods may further comprise recirculating at least a portion of the liquor phase from the second catalytic reduction reactor unit to the hydrothermal digestion unit. In some embodiments, the liquor phase may be recirculated such that countercurrent flow is established in the hydrothermal digestion unit. In other embodiments, other flow patterns may be established in the hydrothermal digestion unit, including co-current flow.

In some embodiments, heating the cellulosic biomass solids in the hydrothermal digestion unit may take place at a pressure of at least about 30 bar. Maintaining digestion at a pressure of at least about 30 bar may ensure that digestion takes place at a satisfactory rate. In some embodiments, heating the cellulosic biomass solids in the hydrothermal digestion unit may take place at a pressure of at least about 60 bar. In some embodiments, heating the cellulosic biomass solids in the hydrothermal digestion unit may take place at a pressure of at least about 90 bar. In some embodiments, heating the cellulosic biomass solids in the hydrothermal digestion unit may take place at a pressure ranging between about 30 bar and about 430 bar. In some embodiments, heating the cellulosic biomass solids in the hydrothermal digestion unit may take place at a pressure ranging between about 50 bar and about 330 bar. In some embodiments, heating the cellulosic biomass solids in the hydrothermal digestion unit may take place at a pressure ranging between about 70 bar and about 130 bar. In some embodiments, heating the cellulosic biomass solids in the hydrothermal digestion unit may take place at a pressure ranging between about 30 bar and about 130 bar. It is to be noted that the foregoing pressures refer to the pressures at which digestion takes place. That is, the foregoing pressures refer to normal operating pressures for the hydrothermal digestion unit.

As set forth above, embodiments of the biomass conversion systems described herein are particularly advantageous in being capable of quickly removing a hydrolysate from the hydrothermal digestion unit and at least partially transforming soluble carbohydrates in the hydrolysate into a reaction product comprising oxygenated intermediates. In accomplishing the foregoing, the liquor phase containing the reaction product may be recirculated from any of the catalytic reduction reactor units to the hydrothermal digestion unit, where the liquor phase may, for example, help regulate temperature therein, serve as a digestion solvent, and the like. Recirculation from the first catalytic reduction reactor unit(s) and the second catalytic reduction reactor unit may take place at various recycle ratios. With regard to the first catalytic reduction reactor unit(s), the term “recycle ratio” refers to the amount of liquor phase that is circulated to the first catalytic reduction reactor unit(s) relative to the amount of liquor phase that is transferred to the fluid circulation loop. With regard to the second catalytic reduction reactor unit, the term “recycle ratio” refers to the amount of liquor phase that is recirculated to the hydrothermal digestion unit relative to the amount of liquor phase that is withdrawn from the fluid circulation loop, by a reaction product take-off line, for example. An advantage of the present biomass conversion systems is that they may allow lower recycle ratios to be used in the fluid circulation loop than for other types of related biomass conversion systems. Accordingly, a relatively high proportion of the liquor phase passing through the fluid circulation loop may be withdrawn for subsequent conversion into a biofuel. Lower recycle ratios may also allow smaller reactor volumes to be used, as total liquid flow velocity in the hydrothermal digestion unit and catalytic reduction reactor are reduced. High recycle ratios and high liquid flow velocities may give rise to excessive pressure drops, high pump energy and size requirements, and other adverse features. Failure to minimize residence time prior to stabilization via a catalytic reduction reaction may also result in lower yields. Given the benefit of the present disclosure, one having ordinary skill in the art will be able to determine an appropriate recycle ratio within fluid circulation loop that achieves a desired amount of heat integration, while balancing a desired rate of downstream biofuel production.

In some embodiments, the liquor phase can be recirculated between the hydrothermal digestion unit and the first catalytic reduction reactor unit(s) at a recycle ratio ranging between about 1 and about 30. In other embodiments, the liquor phase can be recirculated between the hydrothermal digestion unit and the first catalytic reduction reactor unit(s) at a recycle ratio ranging between about 1 and about 20, or between about 1 and about 15, or between about 1 and about 10, or between about 1 and about 5. When more than one first catalytic reduction reactor unit is present, the recycle ratio between each catalytic reduction reactor unit may be the same, in some embodiments, or at least some of the recycle ratios may be different, in other embodiments.

In some embodiments, the liquor phase may be recirculated between within the fluid circulation loop at a recycle ratio ranging between about 0.2 and about 10. That is, in such embodiments, the liquor phase may be recirculated between the second catalytic reduction reactor unit and the hydrothermal digestion unit at a recycle ratio ranging between about 0.2 and about 10. In some embodiments, the liquor phase may be recirculated between the second catalytic reduction reactor unit and the hydrothermal digestion unit at a recycle ratio ranging between about 1 and about 10, or between about 1 and about 5, or between about 0.2 and about 2, or between about 0.5 and about 2, or between about 1 and about 2, or between about 0.2 and about 1, or between about 0.5 and about 1.

In some embodiments, recirculation from the second catalytic reduction reactor unit to the hydrothermal digestion unit (i.e., within the fluid circulation loop), may take place such that countercurrent flow is established in the hydrothermal digestion unit. In some embodiments, recirculation may take place such that a different flow motif is established, such as co-current flow, for example.

In some embodiments, the present methods may further comprise performing a phase separation of the reaction product. In some embodiments, phase separation may take place using a phase separation mechanism that is in fluid communication with the fluid circulation loop following an outlet of the second catalytic reduction reactor unit. In various embodiments, performing a phase separation may comprise separating a bilayer, conducting a solvent stripping operation, performing an extraction, performing a filtration, performing a distillation, or the like. In some embodiments, azeotropic distillation may be conducted.

As described above, embodiments of the hydrothermal digestion unit may be operated over a range of temperatures. Furthermore, the hydrothermal digestion unit may also operate with a temperature gradient therein. That is, in some embodiments, the hydrothermal digestion unit may have a non-uniform temperature distribution about its height. As used herein, a “non-uniform temperature distribution” refers to a condition in which different regions of the hydrothermal digestion unit have different temperatures. In some embodiments, there may be a progressive increase in temperatures proceeding from the top to the bottom of the hydrothermal digestion unit. In some embodiments, a region of the hydrothermal digestion unit having the highest temperature may be in the middle of the hydrothermal digestion unit. Accordingly, cellulosic biomass solids in the hydrothermal digestion unit may be undergoing digestion over a range of temperatures, in some embodiments. In the higher temperature regions of the hydrothermal digestion unit, soluble carbohydrates within the liquor phase may be more susceptible to decomposition. The embodiments described herein may be particularly advantageous for addressing potential degradation of soluble carbohydrates that may arise from the temperature gradient within the hydrothermal digestion unit. Specifically, in some embodiments, the fluid inlet lines and fluid return lines coupling the hydrothermal digestion unit to the first catalytic reduction reactor unit(s) may be more heavily concentrated in the higher temperature regions in order to more efficiently transfer the soluble carbohydrates away from potentially degrading temperatures. In some embodiments, there may be more pairs of fluid inlet lines and fluid return lines in the higher temperature regions of the hydrothermal digestion unit than in lower temperature regions of the hydrothermal digestion unit. In some embodiments, the liquor phase in the hydrothermal digestion unit may be transferred to the first catalytic reduction reactor unit(s) more rapidly from higher temperature regions of the hydrothermal digestion unit than from lower temperature regions of the hydrothermal digestion unit.

In some embodiments, the methods described herein may further comprise converting the hydrolysate into a biofuel. In some embodiments, conversion of the hydrolysate into a biofuel may begin with a catalytic hydrogenolysis reaction to transform soluble carbohydrates produced from digestion into a reaction product comprising oxygenated intermediates, as described above. As described above and depicted in FIGS. 1-3, the reaction product may be recirculated to the hydrothermal digestion unit to further aid in the digestion process. In some embodiments, the reaction product may be further transformed by any number of further catalytic reforming reactions including, for example, further catalytic reduction reactions (e.g., hydrogenolysis reactions, hydrogenation reactions, hydrotreating reactions, and the like), condensation reactions, isomerization reactions, desulfurization reactions, dehydration reactions, oligomerization reactions, alkylation reactions, and the like. A description of the initial hydrogenolysis reaction and the further catalytic reforming reactions are described hereinafter.

Various processes are known for performing hydrogenolysis of carbohydrates. One suitable method includes contacting a carbohydrate or stable hydroxyl intermediate with hydrogen, optionally mixed with a diluent gas, and a hydrogenolysis catalyst under conditions effective to form a reaction product comprising oxygenated intermediates such as, for example, smaller molecules or polyols. As used herein, the term “smaller molecules or polyols” includes any molecule that have a lower molecular weight, which may include a smaller number of carbon atoms or oxygen atoms, than the starting carbohydrate. In some embodiments, the reaction products may include smaller molecules such as, for example, polyols and alcohols. This aspect of hydrogenolysis entails the breaking of carbon-carbon bonds

In some embodiments, a soluble carbohydrate may be converted to relatively stable oxygenated intermediates such as, for example, propylene glycol, ethylene glycol, and glycerol using a hydrogenolysis reaction in the presence of a catalyst that is capable of activating molecular hydrogen. Suitable catalysts may include, for example, Cr, Mo, W, Re, Mn, Cu, Cd, Fe, Co, Ni, Pt, Pd, Rh, Ru, Ir, Os, and alloys or any combination thereof, either alone or with promoters such as Au, Ag, Cr, Zn, Mn, Sn, Bi, B, O, and alloys or any combination thereof. In some embodiments, the catalysts and promoters may allow for hydrogenation and hydrogenolysis reactions to occur at the same time or in succession, such as the hydrogenation of a carbonyl group to form an alcohol. The catalyst may also include a carbonaceous pyropolymer catalyst containing transition metals (e.g., chromium, molybdenum, tungsten, rhenium, manganese, copper, and cadmium) or Group VIII metals (e.g., iron, cobalt, nickel, platinum, palladium, rhodium, ruthenium, iridium, and osmium). In certain embodiments, the catalyst may include any of the above metals combined with an alkaline earth metal oxide or adhered to a catalytically active support. In certain embodiments, the catalyst described in the hydrogenolysis reaction may include a catalyst support.

The conditions under which to carry out the hydrogenolysis reaction will vary based on the type of biomass starting material and the desired products (e.g. gasoline or diesel), for example. One of ordinary skill in the art, with the benefit of this disclosure, will recognize the appropriate conditions to use to carry out the reaction. In general, the hydrogenolysis reaction may be conducted at temperatures in the range of about 110° C. to about 300° C., and preferably from about 170° C. to about 300° C., and most preferably from about 180° C. to about 290° C.

In some embodiments, the hydrogenolysis reaction may be conducted under basic conditions, preferably at a pH of about 7 to about 13, and even more preferably at a pH of about 10 to about 12. In other embodiments, the hydrogenolysis reaction may be conducted under mildly acidic conditions, preferably at a pH from about 5 to about 7. In some embodiments, the hydrogenolysis reaction may be conducted at a pressure ranging between about 1 bar (absolute) and about 150 bar, and preferably at a pressure ranging between about 15 bar and about 140 bar, and even more preferably at a pressure ranging between 50 bar and 110 bar.

The hydrogen used in the hydrogenolysis reaction may include external hydrogen, recycled hydrogen, in situ generated hydrogen, or any combination thereof.

In some embodiments, the reaction products of the hydrogenolysis reaction may comprise greater than about 25% by mole, or alternatively, greater than about 30% by mole of polyols, which may result in a greater conversion to a biofuel in a subsequent processing reaction.

In some embodiments, hydrogenolysis may be conducted under neutral or acidic conditions, as needed to accelerate hydrolysis reactions in addition to the hydrogenolysis reaction. For example, hydrolysis of oligomeric carbohydrates may be combined with hydrogenation to produce sugar alcohols, which may undergo hydrogenolysis.

A second aspect of hydrogenolysis entails the breaking of —OH bonds such as: RC(H)₂-OH+H₂→RCH₃+H₂O. This reaction is also called “hydrodeoxygenation,” and may occur in parallel with C—C bond breaking hydrogenolysis. Diols may be converted to mono-oxygenates via this reaction. As reaction severity is increased with increased temperature or contact time with catalyst, the concentration of polyols and diols relative to mono-oxygenates may diminish as a result of hydrodeoxygenation. Selectivity for C—C vs. C—OH bond hydrogenolysis will vary with catalyst type and formulation. Full de-oxygenation to alkanes may also occur, but is generally undesirable if the intent is to produce mono-oxygenates or diols and polyols which may be condensed or oligomerized to higher molecular weight compounds in a subsequent processing step. Typically, it is desirable to send only mono-oxygenates or diols to subsequent processing steps, as higher polyols may lead to excessive coke formation during condensation or oligomerization. Alkanes, in contrast, are essentially unreactive and cannot be readily combined to produce higher molecular compounds.

Once oxygenated intermediates have been formed by a hydrogenolysis reaction, a portion of the reaction product may be recirculated to the hydrothermal digestion unit to serve as an internally generated digestion solvent. Another portion of the reaction product may be withdrawn and subsequently processed by further reforming reactions to form a biofuel. Before being subjected to the further reforming reactions, the oxygenated intermediates may optionally be separated into different components. Suitable separations may include, for example, phase separation, solvent stripping columns, extractors, filters, distillations and the like. In some embodiments, a separation of lignin from the oxygenated intermediates may be conducted before the reaction product is subsequently processed further or recirculated to the hydrothermal digestion unit.

The oxygenated intermediates may be processed to produce a fuel blend in one or more processing reactions. In some embodiments, a condensation reaction may be used along with other reactions to generate a fuel blend and may be catalyzed by a catalyst comprising an acid, a base, or both. In general, without being limited to any particular theory, it is believed that the basic condensation reactions may involve a series of steps involving: (1) an optional dehydrogenation reaction; (2) an optional dehydration reaction that may be acid catalyzed; (3) an aldol condensation reaction; (4) an optional ketonization reaction; (5) an optional furanic ring opening reaction; (6) hydrogenation of the resulting condensation products to form a ≧C₄ hydrocarbon; and (7) any combination thereof. Acid catalyzed condensations may similarly entail optional hydrogenation or dehydrogenation reactions, dehydration, and oligomerization reactions. Additional polishing reactions may also be used to conform the product to a specific fuel standard, including reactions conducted in the presence of hydrogen and a hydrogenation catalyst to remove functional groups from final fuel product. In some embodiments, a basic catalyst, a catalyst having both an acid and a base functional site, and optionally comprising a metal function, may also be used to effect the condensation reaction.

In some embodiments, an aldol condensation reaction may be used to produce a fuel blend meeting the requirements for a diesel fuel or jet fuel. Traditional diesel fuels are petroleum distillates rich in paraffinic hydrocarbons. They have boiling ranges as broad as 187° C. to 417° C., which are suitable for combustion in a compression ignition engine, such as a diesel engine vehicle. The American Society of Testing and Materials (ASTM) establishes the grade of diesel according to the boiling range, along with allowable ranges of other fuel properties, such as cetane number, cloud point, flash point, viscosity, aniline point, sulfur content, water content, ash content, copper strip corrosion, and carbon residue. Thus, any fuel blend meeting ASTM D975 may be defined as diesel fuel.

In some embodiments, the present disclosure also provides methods to produce jet fuel. Jet fuel is clear to straw colored. The most common fuel is an unleaded/paraffin oil-based fuel classified as Aeroplane A-1, which is produced to an internationally standardized set of specifications. Jet fuel is a mixture of a large number of different hydrocarbons, possibly as many as a thousand or more. The range of their sizes (molecular weights or carbon numbers) is restricted by the requirements for the product, for example, freezing point or smoke point. Kerosene-type Airplane fuel (including Jet A and Jet A-1) has a carbon number distribution between about C₈ and C₁₆. Wide-cut or naphtha-type Airplane fuel (including Jet B) typically has a carbon number distribution between about C₅ and C₁₅. A fuel blend meeting ASTM D1655 may be defined as jet fuel.

In certain embodiments, both Airplanes (Jet A and Jet B) contain a number of additives. Useful additives include, but are not limited to, antioxidants, antistatic agents, corrosion inhibitors, and fuel system icing inhibitor (FSII) agents. Antioxidants prevent gumming and usually, are based on alkylated phenols, for example, AO-30, AO-31, or AO-37. Antistatic agents dissipate static electricity and prevent sparking. Stadis 450 with dinonylnaphthylsulfonic acid (DINNSA) as the active ingredient, is an example. Corrosion inhibitors (e.g., DCI-4A) are used for civilian and military fuels, and DCI-6A is used for military fuels. FSII agents, include, for example, Di-EGME.

In some embodiments, the oxygenated intermediates may comprise a carbonyl-containing compound that may take part in a base catalyzed condensation reaction. In some embodiments, an optional dehydrogenation reaction may be used to increase the amount of carbonyl-containing compounds in the oxygenated intermediate stream to be used as a feed to the condensation reaction. In these embodiments, the oxygenated intermediates and/or a portion of the bio-based feedstock stream may be dehydrogenated in the presence of a catalyst.

In some embodiments, a dehydrogenation catalyst may be preferred for an oxygenated intermediate stream comprising alcohols, diols, and triols. In general, alcohols cannot participate in aldol condensation directly. The hydroxyl group or groups present may be converted into carbonyls (e.g., aldehydes, ketones, etc.) in order to participate in an aldol condensation reaction. A dehydrogenation catalyst may be included to effect dehydrogenation of any alcohols, diols, or polyols present to form ketones and aldehydes. The dehydration catalyst is typically formed from the same metals as used for hydrogenation, hydrogenolysis, or aqueous phase reforming. These catalysts are described in more detail above. Dehydrogenation yields may be enhanced by the removal or consumption of hydrogen as it forms during the reaction. The dehydrogenation step may be carried out as a separate reaction step before an aldol condensation reaction, or the dehydrogenation reaction may be carried out in concert with the aldol condensation reaction. For concerted dehydrogenation and aldol condensation reactions, the dehydrogenation and aldol condensation functions may take place on the same catalyst. For example, a metal hydrogenation/dehydrogenation functionality may be present on catalyst comprising a basic functionality.

The dehydrogenation reaction may result in the production of a carbonyl-containing compound. Suitable carbonyl-containing compounds may include, but are not limited to, any compound comprising a carbonyl functional group that may form carbanion species or may react in a condensation reaction with a carbanion species. In an embodiment, a carbonyl-containing compound may include, but is not limited to, ketones, aldehydes, furfurals, hydroxy carboxylic acids, and, carboxylic acids. Ketones may include, without limitation, hydroxyketones, cyclic ketones, diketones, acetone, propanone, 2-oxopropanal, butanone, butane-2,3-dione, 3-hydroxybutane-2-one, pentanone, cyclopentanone, pentane-2,3-dione, pentane-2,4-dione, hexanone, cyclohexanone, 2-methyl-cyclopentanone, heptanone, octanone, nonanone, decanone, undecanone, dodecanone, methylglyoxal, butanedione, pentanedione, diketohexane, dihydroxyacetone, and isomers thereof. Aldehydes may include, without limitation, hydroxyaldehydes, acetaldehyde, glyceraldehyde, propionaldehyde, butyraldehyde, pentanal, hexanal, heptanal, octanal, nonal, decanal, undecanal, dodecanal, and isomers thereof. Carboxylic acids may include, without limitation, formic acid, acetic acid, propionic acid, butanoic acid, pentanoic acid, hexanoic acid, heptanoic acid, isomers and derivatives thereof, including hydroxylated derivatives, such as 2-hydroxybutanoic acid and lactic acid. Furfurals may include, without limitation, hydroxylmethylfurfural, 5-hydroxymethyl-2(5H)-furanone, dihydro-5-(hydroxymethyl)-2(3H)-furanone, tetrahydro-2-furoic acid, dihydro-5-(hydroxymethyl)-2(3H)-furanone, tetrahydrofurfuryl alcohol, 1-(2-furyl)ethanol, hydroxymethyltetrahydrofurfural, and isomers thereof. In an embodiment, the dehydrogenation reaction may result in the production of a carbonyl-containing compound that is combined with the oxygenated intermediates to become a part of the oxygenated intermediates fed to the condensation reaction.

In an embodiment, an acid catalyst may be used to optionally dehydrate at least a portion of the oxygenated intermediate stream. Suitable acid catalysts for use in the dehydration reaction may include, but are not limited to, mineral acids (e.g., HCl, H₂SO₄), solid acids (e.g., zeolites, ion-exchange resins) and acid salts (e.g., LaCl₃). Additional acid catalysts may include, without limitation, zeolites, carbides, nitrides, zirconia, alumina, silica, aluminosilicates, phosphates, titanium oxides, zinc oxides, vanadium oxides, lanthanum oxides, yttrium oxides, scandium oxides, magnesium oxides, cerium oxides, barium oxides, calcium oxides, hydroxides, heteropolyacids, inorganic acids, acid modified resins, base modified resins, and any combination thereof. In some embodiments, the dehydration catalyst may also include a modifier. Suitable modifiers may include, for example, La, Y, Sc, P, B, Bi, Li, Na, K, Rb, Cs, Mg, Ca, Sr, Ba, and any combination thereof. The modifiers may be useful, inter alia, to carry out a concerted hydrogenation/dehydrogenation reaction with the dehydration reaction. In some embodiments, the dehydration catalyst may also include a metal. Suitable metals may include, for example, Cu, Ag, Au, Pt, Ni, Fe, Co, Ru, Zn, Cd, Ga, In, Rh, Pd, Ir, Re, Mn, Cr, Mo, W, Sn, Os, alloys, and any combination thereof. The dehydration catalyst may be self supporting, supported on an inert support or resin, or it may be dissolved in solution.

In some embodiments, the dehydration reaction may occur in the vapor phase. In other embodiments, the dehydration reaction may occur in the liquid phase. For liquid phase dehydration reactions, an aqueous solution may be used to carry out the reaction. In an embodiment, other solvents in addition to water, may be used to form the aqueous solution. For example, water soluble organic solvents may be present. Suitable solvents may include, but are not limited to, hydroxymethylfurfural (HMF), dimethylsulfoxide (DMSO), 1-methyl-n-pyrollidone (NMP), and any combination thereof. Other suitable aprotic solvents may also be used alone or in combination with any of these solvents.

In an embodiment, the processing reactions may comprise an optional ketonization reaction. A ketonization reaction may increase the number of ketone functional groups within at least a portion of the oxygenated intermediates. For example, an alcohol may be converted into a ketone in a ketonization reaction. Ketonization may be carried out in the presence of a basic catalyst. Any of the basic catalysts described above as the basic component of the aldol condensation reaction may be used to effect a ketonization reaction. Suitable reaction conditions are known to one of ordinary skill in the art and generally correspond to the reaction conditions listed above with respect to the aldol condensation reaction. The ketonization reaction may be carried out as a separate reaction step, or it may be carried out in concert with the aldol condensation reaction. The inclusion of a basic functional site on the aldol condensation catalyst may result in concerted ketonization and aldol condensation reactions.

In some embodiments, the processing reactions may comprise an optional furanic ring opening reaction. A furanic ring opening reaction may result in the conversion of at least a portion of any oxygenated intermediates comprising a furanic ring into compounds that are more reactive in an aldol condensation reaction. A furanic ring opening reaction may be carried out in the presence of an acidic catalyst. Any of the acid catalysts described above as the acid component of the aldol condensation reaction may be used to effect a furanic ring opening reaction. Suitable reaction conditions are known to one of ordinary skill in the art and generally correspond to the reaction conditions listed above with respect to the aldol condensation reaction. The furanic ring opening reaction may be carried out as a separate reaction step, or it may be carried out in concert with the aldol condensation reaction. The inclusion of an acid functional site on the aldol condensation catalyst may result in a concerted furanic ring opening reaction and aldol condensation reactions. Such an embodiment may be advantageous as any furanic rings may be opened in the presence of an acid functionality and reacted in an aldol condensation reaction using a basic functionality. Such a concerted reaction scheme may allow for the production of a greater amount of higher hydrocarbons to be formed for a given oxygenated intermediate feed.

In some embodiments, production of a ≧C₄ compound may occur by condensation, which may include aldol condensation of the oxygenated intermediates in the presence of a condensation catalyst. Aldol-condensation generally involves the carbon-carbon coupling between two compounds, at least one of which may contain a carbonyl group, to form a larger organic molecule. For example, acetone may react with hydroxymethylfurfural to form a C₉ species, which may subsequently react with another hydroxymethylfurfural molecule to form a C₁₅ species. In various embodiments, the reaction is usually carried out in the presence of a condensation catalyst. The condensation reaction may be carried out in the vapor or liquid phase. In an embodiment, the reaction may take place at a temperature ranging from about 5° C. to about 375° C. depending on the reactivity of the carbonyl group.

The condensation catalyst will generally be a catalyst capable of forming longer chain compounds by linking two molecules through a new carbon-carbon bond, such as a basic catalyst, a multi-functional catalyst having both acid and base functionalities, or either type of catalyst also comprising an optional metal functionality. In some embodiments, the multi-functional catalyst may be a catalyst having both strong acid and strong base functionalities. In some embodiments, aldol catalysts may comprise Li, Na, K, Cs, B, Rb, Mg, Ca, Sr, Si, Ba, Al, Zn, Ce, La, Y, Sc, Y, Zr, Ti, hydrotalcite, zinc-aluminate, phosphate, base-treated aluminosilicate zeolite, a basic resin, basic nitride, alloys or any combination thereof. In some embodiments, the base catalyst may also comprise an oxide of Ti, Zr, V, Nb, Ta, Mo, Cr, W, Mn, Re, Al, Ga, In, Co, Ni, Si, Cu, Zn, Sn, Cd, Mg, P, Fe, or any combination thereof. In some embodiments, the condensation catalyst comprises mixed-oxide base catalysts. Suitable mixed-oxide base catalysts may comprise a combination of magnesium, zirconium, and oxygen, which may comprise, without limitation: Si—Mg—O, Mg—Ti—O, Y—Mg—O, Y—Zr—O, Ti—Zr—O, Ce—Zr—O, Ce—Mg—O, Ca—Zr—O, La—Zr—O, B—Zr—O, La—Ti—O, B—Ti—O, and any combination thereof. Different atomic ratios of Mg/Zr or the combinations of various other elements constituting the mixed oxide catalyst may be used ranging from about 0.01 to about 50. In some embodiments, the condensation catalyst may further include a metal or alloys comprising metals, such as Cu, Ag, Au, Pt, Ni, Fe, Co, Ru, Zn, Cd, Ga, In, Rh, Pd, Ir, Re, Mn, Cr, Mo, W, Sn, Bi, Pb, Os, alloys and combinations thereof. Such metals may be preferred when a dehydrogenation reaction is to be carried out in concert with the aldol condensation reaction. In some embodiments, preferred Group IA materials may include Li, Na, K, Cs and Rb. In some embodiments, preferred Group IIA materials may include Mg, Ca, Sr and Ba. In some embodiments, Group IIB materials may include Zn and Cd. In some embodiments, Group IIIB materials may include Y and La. Basic resins may include resins that exhibit basic functionality. The basic catalyst may be self-supporting or adhered to any one of the supports further described below, including supports containing carbon, silica, alumina, zirconia, titania, vanadia, ceria, nitride, boron nitride, heteropolyacids, alloys and mixtures thereof.

In one embodiment, the condensation catalyst may be derived from the combination of MgO and Al₂O₃ to form a hydrotalcite material. Another preferred material contains ZnO and Al₂O₃ in the form of a zinc aluminate spinel. Yet another preferred material is a combination of ZnO, Al₂O₃, and CuO. Each of these materials may also contain an additional metal function provided by a Group VIIIB metal, such as Pd or Pt. Such metals may be preferred when a dehydrogenation reaction is to be carried out in concert with the aldol condensation reaction. In some embodiments, the basic catalyst may be a metal oxide containing Cu, Ni, Zn, V, Zr, or mixtures thereof. In other embodiments, the basic catalyst may be a zinc aluminate metal containing Pt, Pd Cu, Ni, or mixtures thereof.

In some embodiments, a base-catalyzed condensation reaction may be performed using a condensation catalyst with both an acidic and a basic functionality. The acid-aldol condensation catalyst may comprise hydrotalcite, zinc-aluminate, phosphate, Li, Na, K, Cs, B, Rb, Mg, Si, Ca, Sr, Ba, Al, Ce, La, Sc, Y, Zr, Ti, Zn, Cr, or any combination thereof. In further embodiments, the acid-base catalyst may also include one or more oxides from the group of Ti, Zr, V, Nb, Ta, Mo, Cr, W, Mn, Re, Al, Ga, In, Fe, Co, Ir, Ni, Si, Cu, Zn, Sn, Cd, P, and combinations thereof. In some embodiments, the acid-base catalyst may include a metal functionality provided by Cu, Ag, Au, Pt, Ni, Fe, Co, Ru, Zn, Cd, Ga, In, Rh, Pd, Ir, Re, Mn, Cr, Mo, W, Sn, Os, alloys or combinations thereof. In some embodiments, the catalyst may further include Zn, Cd or phosphate. In some embodiments, the condensation catalyst may be a metal oxide containing Pd, Pt, Cu or Ni, and even more preferably an aluminate or zirconium metal oxide containing Mg and Cu, Pt, Pd or Ni. The acid-base catalyst may also include a hydroxyapatite (HAP) combined with any one or more of the above metals. The acid-base catalyst may be self-supporting or adhered to any one of the supports further described below, including supports containing carbon, silica, alumina, zirconia, titania, vanadia, ceria, nitride, boron nitride, heteropolyacids, alloys and mixtures thereof.

In some embodiments, the condensation catalyst may also include zeolites and other microporous supports that contain Group IA compounds, such as Li, Na, K, Cs and Rb. Preferably, the Group IA material may be present in an amount less than that required to neutralize the acidic nature of the support. A metal function may also be provided by the addition of group VIIIB metals, or Cu, Ga, In, Zn or Sn. In one embodiment, the condensation catalyst may be derived from the combination of MgO and Al₂O₃ to form a hydrotalcite material. Another preferred material may contain a combination of MgO and ZrO₂, or a combination of ZnO and Al₂O₃. Each of these materials may also contain an additional metal function provided by copper or a Group VIIIB metal, such as Ni, Pd, Pt, or combinations of the foregoing.

The condensation catalyst may be self-supporting (i.e., the catalyst does not need another material to serve as a support), or may require a separate support suitable for suspending the catalyst in the reactant stream. One exemplary support is silica, especially silica having a high surface area (greater than 100 square meters per gram), obtained by sol-gel synthesis, precipitation, or fuming. In other embodiments, particularly when the condensation catalyst is a powder, the catalyst system may include a binder to assist in forming the catalyst into a desirable catalyst shape. Applicable forming processes may include extrusion, pelletization, oil dropping, or other known processes. Zinc oxide, alumina, and a peptizing agent may also be mixed together and extruded to produce a formed material. After drying, this material may be calcined at a temperature appropriate for formation of the catalytically active phase. Other catalyst supports as known to one having ordinary skill in the art may also be used.

In some embodiments, a dehydration catalyst, a dehydrogenation catalyst, and the condensation catalyst may be present in the same reactor as the reaction conditions overlap to some degree. In these embodiments, a dehydration reaction and/or a dehydrogenation reaction may occur substantially simultaneously with the condensation reaction. In some embodiments, a catalyst may comprise active sites for a dehydration reaction and/or a dehydrogenation reaction in addition to a condensation reaction. For example, a catalyst may comprise active metals for a dehydration reaction and/or a dehydrogenation reaction along with a condensation reaction at separate sites on the catalyst or as alloys. Suitable active elements may comprise any of those listed above with respect to the dehydration catalyst, dehydrogenation catalyst, and the condensation catalyst. Alternately, a physical mixture of dehydration, dehydrogenation, and condensation catalysts may be employed. While not intending to be limited by theory, it is believed that using a condensation catalyst comprising a metal and/or an acid functionality may assist in pushing the equilibrium limited aldol condensation reaction toward completion. Advantageously, this may be used to effect multiple condensation reactions with dehydration and/or dehydrogenation of intermediates, in order to form (via condensation, dehydration, and/or dehydrogenation) higher molecular weight oligomers as desired to produce jet or diesel fuel.

The specific ≧C₄ compounds produced in the condensation reaction may depend on various factors, including, without limitation, the type of oxygenated intermediates in the reactant stream, condensation temperature, condensation pressure, the reactivity of the catalyst, and the flow rate of the reactant stream. In general, the condensation reaction may be carried out at a temperature at which the thermodynamics of the proposed reaction are favorable. For condensed phase liquid reactions, the pressure within the reactor may be sufficient to maintain at least a portion of the reactants in the condensed liquid phase at the reactor inlet. For vapor phase reactions, the reaction may be carried out at a temperature where the vapor pressure of the oxygenates is at least about 0.1 bar, and the thermodynamics of the reaction are favorable. The condensation temperature will vary depending upon the specific oxygenated intermediates used, but may generally range between about 75° C. and about 500° C. for reactions taking place in the vapor phase, and more preferably range between about 125° C. and about 450° C. For liquid phase reactions, the condensation temperature may range between about 5° C. and about 475° C., and the condensation pressure may range between about 0.01 bar and about 100 bar. Preferably, the condensation temperature may range between about 15° C. and about 300° C., or between about 15° C. and 250° C.

Varying the factors above, as well as others, will generally result in a modification to the specific composition and yields of the ≧C₄ compounds. For example, varying the temperature and/or pressure of the reactor system, or the particular catalyst formulations, may result in the production of ≧C₄ alcohols and/or ketones instead of ≧C₄ hydrocarbons. The ≧C₄ hydrocarbon product may also contain a variety of olefins, and alkanes of various sizes (typically branched alkanes). Depending upon the condensation catalyst used, the hydrocarbon product may also include aromatic and cyclic hydrocarbon compounds. The ≧C₄ hydrocarbon product may also contain undesirably high levels of olefins, which may lead to coking or deposits in combustion engines, or other undesirable hydrocarbon products. In such cases, the hydrocarbons may optionally be hydrogenated to reduce the ketones to alcohols and hydrocarbons, while the alcohols and olefinic hydrocarbons may be reduced to alkanes, thereby forming a more desirable hydrocarbon product having reduced levels of olefins, aromatics or alcohols.

The condensation reactions may be carried out in any reactor of suitable design, including continuous-flow, batch, semi-batch or multi-system reactors, without limitation as to design, size, geometry, flow rates, and the like. The reactor system may also use a fluidized catalytic bed system, a swing bed system, fixed bed system, a moving bed system, or a combination of the above. In some embodiments, bi-phasic (e.g., liquid-liquid) and tri-phasic (e.g., liquid-liquid-solid) reactors may be used to carry out the condensation reactions.

In a continuous flow system, the reactor system may include an optional dehydrogenation bed adapted to produce dehydrogenated oxygenated intermediates, an optional dehydration bed adapted to produce dehydrated oxygenated intermediates, and a condensation bed adapted to produce ≧C₄ compounds from the oxygenated intermediates. The dehydrogenation bed may be configured to receive the reactant stream and produce the desired oxygenated intermediates, which may have an increase in the amount of carbonyl-containing compounds. The dehydration bed may be configured to receive the reactant stream and produce the desired oxygenated intermediates. The condensation bed may be configured to receive the oxygenated intermediates for contact with the condensation catalyst and production of the desired ≧C₄ compounds. For systems with one or more finishing steps, an additional reaction bed for conducting the finishing process or processes may be included after the condensation bed.

In some embodiments, the optional dehydration reaction, the optional dehydrogenation reaction, the optional ketonization reaction, the optional ring opening reaction, and the condensation reaction catalyst beds may be positioned within the same reactor vessel or in separate reactor vessels in fluid communication with each other. Each reactor vessel preferably may include an outlet adapted to remove the product stream from the reactor vessel. For systems with one or more finishing steps, the finishing reaction bed or beds may be within the same reactor vessel along with the condensation bed or in a separate reactor vessel in fluid communication with the reactor vessel having the condensation bed.

In some embodiments, the reactor system also may include additional outlets to allow for the removal of portions of the reactant stream to further advance or direct the reaction to the desired reaction products, and to allow for the collection and recycling of reaction byproducts for use in other portions of the system. In some embodiments, the reactor system also may include additional inlets to allow for the introduction of supplemental materials to further advance or direct the reaction to the desired reaction products, and to allow for the recycling of reaction byproducts for use in other reactions.

In some embodiments, the reactor system also may include elements which allow for the separation of the reactant stream into different components which may find use in different reaction schemes or to simply promote the desired reactions. For instance, a separator unit, such as a phase separator, extractor, purifier or distillation column, may be installed prior to the condensation step to remove water from the reactant stream for purposes of advancing the condensation reaction to favor the production of higher hydrocarbons. In some embodiments, a separation unit may be installed to remove specific intermediates to allow for the production of a desired product stream containing hydrocarbons within a particular carbon number range, or for use as end products or in other systems or processes. The condensation reaction may produce a broad range of compounds with carbon numbers ranging from C₄ to C₃₀ or greater. Exemplary compounds may include, for example, ≧C₄ alkanes, ≧C₄ alkenes, ≧C₅ cycloalkanes, ≧C₅ cycloalkenes, aryls, fused aryls, ≧C₄ alcohols, ≧C₄ ketones, and mixtures thereof. The ≧C₄ alkanes and ≧C₄ alkenes may range from 4 to about 30 carbon atoms (i.e. C₄-C₃₀ alkanes and C₄-C₃₀ alkenes) and may be branched or straight chain alkanes or alkenes. The ≧C₄ alkanes and ≧C₄ alkenes may also include fractions of C₇-C₁₄, C₁₂-C₂₄ alkanes and alkenes, respectively, with the C₇-C₁₄ fraction directed to jet fuel blends, and the C₁₂-C₂₄ fraction directed to diesel fuel blends and other industrial applications. Examples of various ≧C₄ alkanes and ≧C₄ alkenes may include, without limitation, butane, butene, pentane, pentene, 2-methylbutane, hexane, hexene, 2-methylpentane, 3-methylpentane, 2,2-dimethylbutane, 2,3-dimethylbutane, heptane, heptene, octane, octene, 2,2,4,-trimethylpentane, 2,3-dimethyl hexane, 2,3,4-trimethylpentane, 2,3-dimethylpentane, nonane, nonene, decane, decene, undecane, undecene, dodecane, dodecene, tridecane, tridecene, tetradecane, tetradecene, pentadecane, pentadecene, hexadecane, hexadecene, heptyldecane, heptyldecene, octyldecane, octyldecene, nonyldecane, nonyldecene, eicosane, eicosene, uneicosane, uneicosene, doeicosane, doeicosene, trieicosane, trieicosene, tetraeicosane, tetraeicosene, and isomers thereof.

The ≧C₅ cycloalkanes and ≧C₅ cycloalkenes may have from 5 to about 30 carbon atoms and may be unsubstituted, mono-substituted or multi-substituted. In the case of mono-substituted and multi-substituted compounds, the substituted group may include a branched ≧C₃ alkyl, a straight chain ≧C₁ alkyl, a branched ≧C₃ alkylene, a straight chain ≧C₁ alkylene, a straight chain ≧C₂ alkylene, an aryl group, or a combination thereof. In one embodiment, at least one of the substituted groups may include a branched C₃-C₁₂ alkyl, a straight chain C₁-C₁₂ alkyl, a branched C₃-C₁₂ alkylene, a straight chain C₁-C₁₂ alkylene, a straight chain C₂-C₁₂ alkylene, an aryl group, or a combination thereof. In yet other embodiments, at least one of the substituted groups may include a branched C₃-C₄ alkyl, a straight chain C₁-C₄ alkyl, a branched C₃-C₄ alkylene, a straight chain C₁-C₄ alkylene, a straight chain C₂-C₄ alkylene, an aryl group, or any combination thereof. Examples of desirable ≧C₅ cycloalkanes and ≧C₅ cycloalkenes may include, without limitation, cyclopentane, cyclopentene, cyclohexane, cyclohexene, methylcyclopentane, methylcyclopentene, ethylcyclopentane, ethylcyclopentene, ethylcyclohexane, ethylcyclohexene, and isomers thereof.

Aryl groups contain an aromatic hydrocarbon in either an unsubstituted (phenyl), mono-substituted or multi-substituted form. In the case of mono-substituted and multi-substituted compounds, the substituted group may include a branched ≧C₃ alkyl, a straight chain ≧C₁ alkyl, a branched ≧C₃ alkylene, a straight chain ≧C2 alkylene, a phenyl group, or a combination thereof. In some embodiments, at least one of the substituted groups may include a branched C₃-C₁₂ alkyl, a straight chain C₁-C₁₂ alkyl, a branched C₃-C₁₂ alkylene, a straight chain C₂-C₁₂ alkylene, a phenyl group, or any combination thereof. In yet other embodiments, at least one of the substituted groups may include a branched C₃-C₄ alkyl, a straight chain C₁-C₄ alkyl, a branched C₃-C₄ alkylene, a straight chain C₂-C₄ alkylene, a phenyl group, or any combination thereof. Examples of various aryl compounds may include, without limitation, benzene, toluene, xylene (dimethylbenzene), ethyl benzene, para-xylene, meta-xylene, ortho-xylene, and C9 aromatics.

Fused aryls contain bicyclic and polycyclic aromatic hydrocarbons, in either an unsubstituted, mono-substituted or multi-substituted form. In the case of mono-substituted and multi-substituted compounds, the substituted group may include a branched ≧C₃ alkyl, a straight chain ≧C₁ alkyl, a branched ≧C₃ alkylene, a straight chain ≧C₂ alkylene, a phenyl group, or a combination thereof. In other embodiments, at least one of the substituted groups may include a branched C₃-C₄ alkyl, a straight chain C₁-C₄ alkyl, a branched C₃-C₄ alkylene, a straight chain C₂-C₄ alkylene, a phenyl group, or any combination thereof. Examples of various fused aryls may include, without limitation, naphthalene, anthracene, tetrahydronaphthalene, and decahydronaphthalene, indane, indene, and isomers thereof.

The moderate fractions, such as C₇-C₁₄, may be separated for jet fuel, while heavier fractions, such as C₁₂-C₂₄, may be separated for diesel use. The heaviest fractions may be used as lubricants or cracked to produce additional gasoline and/or diesel fractions. The ≧C₄ compounds may also find use as industrial chemicals, whether as an intermediate or an end product. For example, the aryls toluene, xylene, ethylbenzene, para-xylene, meta-xylene, and ortho-xylene may find use as chemical intermediates for the production of plastics and other products. Meanwhile, C₉ aromatics and fused aryls, such as naphthalene, anthracene, tetrahydronaphthalene, and decahydronaphthalene, may find use as solvents in industrial processes.

In some embodiments, additional processes may be used to treat the fuel blend to remove certain components or further conform the fuel blend to a diesel or jet fuel standard. Suitable techniques may include hydrotreating to reduce the amount of or remove any remaining oxygen, sulfur, or nitrogen in the fuel blend. The conditions for hydrotreating a hydrocarbon stream will be known to one of ordinary skill in the art.

In some embodiments, hydrogenation may be carried out in place of or after the hydrotreating process to saturate at least some olefinic bonds. In some embodiments, a hydrogenation reaction may be carried out in concert with the aldol condensation reaction by including a metal functional group with the aldol condensation catalyst. Such hydrogenation may be performed to conform the fuel blend to a specific fuel standard (e.g., a diesel fuel standard or a jet fuel standard). The hydrogenation of the fuel blend stream may be carried out according to known procedures, either with the continuous or batch method. The hydrogenation reaction may be used to remove remaining carbonyl groups and/or hydroxyl groups. In such cases, any of the hydrogenation catalysts described above may be used. In general, the finishing step may be carried out at finishing temperatures ranging between about 80° C. and about 250° C., and finishing pressures may range between about 5 bar and about 150 bar. In some embodiments, the finishing step may be conducted in the vapor phase or liquid phase, and use, external hydrogen, recycled hydrogen, or combinations thereof, as necessary.

In some embodiments, isomerization may be used to treat the fuel blend to introduce a desired degree of branching or other shape selectivity to at least some components in the fuel blend. It may also be useful to remove any impurities before the hydrocarbons are contacted with the isomerization catalyst. The isomerization step may comprise an optional stripping step, wherein the fuel blend from the oligomerization reaction may be purified by stripping with water vapor or a suitable gas such as light hydrocarbon, nitrogen or hydrogen. The optional stripping step may be carried out in a countercurrent manner in a unit upstream of the isomerization catalyst, wherein the gas and liquid are contacted with each other, or before the actual isomerization reactor in a separate stripping unit utilizing countercurrent principle.

After the optional stripping step the fuel blend may be passed to a reactive isomerization unit comprising one or more catalyst beds. The catalyst beds of the isomerization unit may operate either in co-current or countercurrent manner. In the isomerization unit, the pressure may vary between about 20 bar to about 150 bar, preferably between about 20 bar to about 100 bar, the temperature ranging between about 195° C. and about 500° C., preferably between about 300° C. and about 400° C. In the isomerization unit, any isomerization catalyst known in the art may be used. In some embodiments, suitable isomerization catalysts may contain molecular sieve and/or a metal from Group VII and/or a carrier. In some embodiments, the isomerization catalyst may contain SAPO-11 or SAPO41 or ZSM-22 or ZSM-23 or ferrierite and Pt, Pd or Ni and Al₂O₃ or SiO₂. Typical isomerization catalysts may include, for example, Pt/SAPO-11/Al₂O₃, Pt/ZSM-22/Al₂O₃, Pt/ZSM-23/Al₂O₃ and Pt/SAPO-11/SiO₂.

Other factors, such as the concentration of water or undesired oxygenated intermediates, may also effect the composition and yields of the ≧C₄ compounds, as well as the activity and stability of the condensation catalyst. In such cases, the process may include a dewatering step that removes a portion of the water prior to the condensation reaction and/or the optional dehydration reaction, or a separation unit for removal of the undesired oxygenated intermediates. For instance, a separator unit, such as a phase separator, extractor, purifier or distillation column, may be installed prior to the condensation reactor so as to remove a portion of the water from the reactant stream containing the oxygenated intermediates. A separation unit may also be installed to remove specific oxygenated intermediates to allow for the production of a desired product stream containing hydrocarbons within a particular carbon range, or for use as end products or in other systems or processes.

Thus, in some embodiments, the fuel blend produced by the processes described herein may be a hydrocarbon mixture that meets the requirements for jet fuel (e.g., conforms with ASTM D1655). In other embodiments, the product of the processes described herein may be a hydrocarbon mixture that comprises a fuel blend meeting the requirements for a diesel fuel (e.g., conforms with ASTM D975).

In other embodiments, a fuel blend comprising gasoline hydrocarbons (i.e., a gasoline fuel) may be produced. “Gasoline hydrocarbons” refer to hydrocarbons predominantly comprising C₅₋₉ hydrocarbons, for example, C₆₋₈ hydrocarbons, and having a boiling point range from 32° C. (90° F.) to about 204° C. (400° F.). Gasoline hydrocarbons may include, but are not limited to, straight run gasoline, naphtha, fluidized or thermally catalytically cracked gasoline, VB gasoline, and coker gasoline. Gasoline hydrocarbons content is determined by ASTM Method D2887.

In yet other embodiments, the ≧C₂ olefins may be produced by catalytically reacting the oxygenated intermediates in the presence of a dehydration catalyst at a dehydration temperature and dehydration pressure to produce a reaction stream comprising the ≧C₂ olefins. The ≧C₂ olefins may comprise straight or branched hydrocarbons containing one or more carbon-carbon double bonds. In general, the ≧C₂ olefins may contain from 2 to 8 carbon atoms, and more preferably from 3 to 5 carbon atoms. In some embodiments, the olefins may comprise propylene, butylene, pentylene, isomers of the foregoing, and mixtures of any two or more of the foregoing. In other embodiments, the ≧C₂ olefins may include ≧C₄ olefins produced by catalytically reacting a portion of the ≧C₂ olefins over an olefin isomerization catalyst.

The dehydration catalyst may comprise a member selected from the group consisting of an acidic alumina, aluminum phosphate, silica-alumina phosphate, amorphous silica-alumina, aluminosilicate, zirconia, sulfated zirconia, tungstated zirconia, tungsten carbide, molybdenum carbide, titania, sulfated carbon, phosphated carbon, phosphated silica, phosphated alumina, acidic resin, heteropolyacid, inorganic acid, and a combination of any two or more of the foregoing. In some embodiments, the dehydration catalyst may further comprise a modifier selected from the group consisting of Ce, Y, Sc, La, Li, Na, K, Rb, Cs, Mg, Ca, Sr, Ba, P, B, Bi, and a combination of any two or more of the foregoing. In other embodiments, the dehydration catalyst may further comprise an oxide of an element, the element selected from the group consisting of Ti, Zr, V, Nb, Ta, Mo, Cr, W, Mn, Re, Al, Ga, In, Fe, Co, Ir, Ni, Si, Cu, Zn, Sn, Cd, P, and a combination of any two or more of the foregoing. In yet other embodiments, the dehydration catalyst may further comprise a metal selected from the group consisting of Cu, Ag, Au, Pt, Ni, Fe, Co, Ru, Zn, Cd, Ga, In, Rh, Pd, Ir, Re, Mn, Cr, Mo, W, Sn, Os, an alloy of any two or more of the foregoing, and a combination of any two or more of the foregoing.

In yet other embodiments, the dehydration catalyst may comprise an aluminosilicate zeolite. In some embodiments, the dehydration catalyst may further comprise a modifier selected from the group consisting of Ga, In, Zn, Fe, Mo, Ag, Au, Ni, P, Sc, Y, Ta, a lanthanide, and a combination of any two or more of the foregoing. In some embodiments, the dehydration catalyst may further comprise a metal selected from the group consisting of Cu, Ag, Au, Pt, Ni, Fe, Co, Ru, Zn, Cd, Ga, In, Rh, Pd, Ir, Re, Mn, Cr, Mo, W, Sn, Os, an alloy of any two or more of the foregoing, and a combination of any two or more of the foregoing.

In other embodiments, the dehydration catalyst may comprise a bifunctional pentasil ring-containing aluminosilicate zeolite. In some embodiments, the dehydration catalyst may further comprise a modifier selected from the group consisting of Ga, In, Zn, Fe, Mo, Ag, Au, Ni, P, Sc, Y, Ta, a lanthanide, and a combination of any two or more of the foregoing. In some embodiments, the dehydration catalyst may further comprise a metal selected from the group consisting of Cu, Ag, Au, Pt, Ni, Fe, Co, Ru, Zn, Cd, Ga, In, Rh, Pd, Ir, Re, Mn, Cr, Mo, W, Sn, Os, an alloy of any two or more of the foregoing, and a combination of any two or more of the foregoing.

The dehydration reaction may be conducted at a temperature and pressure where the thermodynamics are favorable. In general, the reaction may be performed in the vapor phase, liquid phase, or a combination of both. In some embodiments, the dehydration temperature may range between about 100° C. and about 500° C., and the dehydration pressure may range between about 1 bar (absolute) and about 60 bar. In some embodiments, the dehydration temperature may range between about 125° C. and about 450° C. In some embodiments, the dehydration temperature may range between about 150° C. and about 350° C., and the dehydration pressure may range between about 5 bar and about 50 bar. In some embodiments, the dehydration temperature may range between about 175° C. and about 325° C.

The ≧C₆ paraffins may be produced by catalytically reacting ≧C₂ olefins with a stream of ≧C₄ isoparaffins in the presence of an alkylation catalyst at an alkylation temperature and alkylation pressure to produce a product stream comprising ≧C₆ paraffins. The ≧C₄ isoparaffins may include alkanes and cycloalkanes having 4 to 7 carbon atoms, such as isobutane, isopentane, naphthenes, and higher homologues having a tertiary carbon atom (e.g., 2-methylbutane and 2,4-dimethylpentane), isomers of the foregoing, and mixtures of any two or more of the foregoing. In some embodiments, the stream of ≧C₄ isoparaffins may comprise internally generated ≧C₄ isoparaffins, external ≧C₄ isoparaffins, recycled ≧C₄ isoparaffins, or combinations of any two or more of the foregoing.

The ≧C₆ paraffins may be branched paraffins, but may also include normal paraffins. In one version, the ≧C₆ paraffins may comprise a member selected from the group consisting of a branched C₆₋₁₀ alkane, a branched C₆ alkane, a branched C₇ alkane, a branched C₈ alkane, a branched C₉ alkane, a branched C₁₀ alkane, or a mixture of any two or more of the foregoing. In one version, the ≧C₆ paraffins may include, for example, dimethylbutane, 2,2-dimethylbutane, 2,3-dimethylbutane, methylpentane, 2-methylpentane, 3-methylpentane, dimethylpentane, 2,3-dimethylpentane, 2,4-dimethylpentane, methylhexane, 2,3-dimethylhexane, 2,3,4-trimethylpentane, 2,2,4-trimethylpentane, 2,2,3-trimethylpentane, 2,3,3-trimethylpentane, dimethylhexane, or mixtures of any two or more of the foregoing.

The alkylation catalyst may comprise a member selected from the group of sulfuric acid, hydrofluoric acid, aluminum chloride, boron trifluoride, solid phosphoric acid, chlorided alumina, acidic alumina, aluminum phosphate, silica-alumina phosphate, amorphous silica-alumina, aluminosilicate, aluminosilicate zeolite, zirconia, sulfated zirconia, tungstated zirconia, tungsten carbide, molybdenum carbide, titania, sulfated carbon, phosphated carbon, phosphated silica, phosphated alumina, acidic resin, heteropolyacid, inorganic acid, and a combination of any two or more of the foregoing. The alkylation catalyst may also include a mixture of a mineral acid with a Friedel-Crafts metal halide, such as aluminum bromide, and other proton donors.

In some embodiments, the alkylation catalyst may comprise an aluminosilicate zeolite. In some embodiments, the alkylation catalyst may further comprise a modifier selected from the group consisting of Ga, In, Zn, Fe, Mo, Ag, Au, Ni, P, Sc, Y, Ta, a lanthanide, and a combination of any two or more of the foregoing. In some embodiments, the alkylation catalyst may further comprise a metal selected from the group consisting of Cu, Ag, Au, Pt, Ni, Fe, Co, Ru, Zn, Cd, Ga, In, Rh, Pd, Ir, Re, Mn, Cr, Mo, W, Sn, Os, an alloy of any two or more of the foregoing, and a combination of any two or more of the foregoing.

In some embodiments, the alkylation catalyst may comprise a bifunctional pentasil ring-containing aluminosilicate zeolite. In some embodiments, the alkylation catalyst may further comprise a modifier selected from the group consisting of Ga, In, Zn, Fe, Mo, Ag, Au, Ni, P, Sc, Y, Ta, a lanthanide, and a combination of any two or more of the foregoing. In some embodiments, the alkylation catalyst may further comprise a metal selected from the group consisting of Cu, Ag, Au, Pt, Ni, Fe, Co, Ru, Zn, Cd, Ga, In, Rh, Pd, Ir, Re, Mn, Cr, Mo, W, Sn, Os, an alloy of any two or more of the foregoing, and a combination of any two or more of the foregoing. In one version, the dehydration catalyst and the alkylation catalyst may be atomically identical.

The alkylation reaction may be conducted at a temperature where the thermodynamics are favorable. In general, the alkylation temperature may range between about −20° C. and about 300° C., and the alkylation pressure may range between about 1 bar (absolute) and about 80 bar. In some embodiments, the alkylation temperature may range between about 100° C. and about 300° C. In another version, the alkylation temperature may range between about 0° C. and about 100° C. In yet other embodiments, the alkylation temperature may range between about 0° C. and about 50° C. In still other embodiments, the alkylation temperature may range between about 70° C. and about 250° C., and the alkylation pressure may range between about 5 bar and about 80 bar. In some embodiments, the alkylation catalyst may comprise a mineral acid or a strong acid. In other embodiments, the alkylation catalyst may comprise a zeolite and the alkylation temperature may be greater than about 100° C.

In some embodiments, an olefinic oligomerization reaction may be conducted. The oligomerization reaction may be carried out in any suitable reactor configuration. Suitable configurations may include, but are not limited to, batch reactors, semi-batch reactors, or continuous reactor designs such as, for example, fluidized bed reactors with external regeneration vessels. Reactor designs may include, but are not limited to tubular reactors, fixed bed reactors, or any other reactor type suitable for carrying out the oligomerization reaction. In some embodiments, a continuous oligomerization process for the production of diesel and jet fuel boiling range hydrocarbons may be carried out using an oligomerization reactor for contacting an olefinic feed stream comprising short chain olefins having a chain length of from 2 to 8 carbon atoms with a zeolite catalyst under elevated temperature and pressure so as to convert the short chain olefins to a fuel blend in the diesel boiling range. The oligomerization reactor may be operated at relatively high pressures of about 20 bar to about 100 bar, and temperatures ranging between about 150° C. and about 300° C., preferably between about 200° C. to 250° C.

The resulting oligomerization stream results in a fuel blend that may have a wide variety of products including products comprising C₅ to C₂₄ hydrocarbons. Additional processing may be used to obtain a fuel blend meeting a desired standard. An initial separation step may be used to generate a fuel blend with a narrower range of carbon numbers. In some embodiments, a separation process such as a distillation process may be used to generate a fuel blend comprising C₁₂ to C₂₄ hydrocarbons for further processing. The remaining hydrocarbons may be used to produce a fuel blend for gasoline, recycled to the oligomerization reactor, or used in additional processes. For example, a kerosene fraction may be derived along with the diesel fraction and may either be used as an illuminating paraffin, as a jet fuel blending component in conventional crude or synthetic derived jet fuels, or as reactant (especially C₁₀ to C₁₃ fraction) in the process to produce LAB (Linear Alkyl Benzene). The naphtha fraction, after hydroprocessing, may be routed to a thermal cracker for the production of ethylene and propylene or routed to a catalytic cracker to produce ethylene, propylene, and gasoline.

Additional processes may be used to treat the fuel blend to remove certain components or further conform the fuel blend to a diesel or jet fuel standard. Suitable techniques may include hydrotreating to remove any remaining oxygen, sulfur, or nitrogen in the fuel blend. Hydrogenation may be carried after the hydrotreating process to saturate at least some olefinic bonds. Such hydrogenation may be performed to conform the fuel blend to a specific fuel standard (e.g., a diesel fuel standard or a jet fuel standard). The hydrogenation step of the fuel blend stream may be carried out according to the known procedures, in a continuous or batchwise manner.

To facilitate a better understanding of the present invention, the following examples of preferred embodiments are given. In no way should the following examples be read to limit, or to define, the scope of the invention.

### EXAMPLES

Reaction studies were conducted in a Parr5000 Hastelloy multireactor containing 6×75 mL reactors operated in parallel at pressures up to 135 bar and temperatures up to 275° C., each stirred by magnetic stir bar. Alternate studies were conducted in 100 mL reactors at 135 bar and 275° C., each stirred by a top-driven stir shaft impeller. Larger scale extraction, pretreatment and digestion tests were conducted in a 1 L Parr reactor with an annular basket housing biomass feed, or with a filtered dip tube for direct contacting of biomass slurries.

Reaction samples were analyzed for sugar, polyol, and organic acids by HPLC using a Bio-Rad Aminex HPX-87H column (300 mm×7.8 mm) operated at a flow rate of 0.6 mL/min of a mobile phase of 5 mM sulfuric acid in water at an oven temperature of 30° C. The run time was 70 minutes, and detection was based on both RI and UV (320 nm).

Product formation (mono-oxygenates, glycols, diols, alkanes, and acids) was monitored by gas chromatograph. Gas chromatographic analyses were conducted using a 60 m×0.32 mm ID DB-5 column of 1 μm thickness, with 50:1 split ratio, 2 mL/min helium flow, and column oven temperature of 40° C. for 8 minutes, followed by a ramp to 285° C. at 10° C./min and a hold time of 53.5 minutes. The injector temperature was set at 250° C., and the detector temperature was set at 300° C.

Gasoline production potential by condensation was assessed via injection of 1 μL aliquots of liquid intermediate product into a catalytic pulse microreactor having a GC insert packed with 0.12 grams of ZSM-5 catalyst, held at 375° C., followed by Restek Rtx-1701 (60 m) and DB-5 (60 m) capillary GC columns in series (120 m total length, 0.32 mm ID, 0.25 μm film thickness). Detection took place using an Agilent/HP 6890 GC equipped with a flame ionization detector. The helium flow was 2.0 mL/min (constant flow mode) at a 10:1 split ratio. The oven temperature was held at 35° C. for 10 minutes, followed by a ramp to 270° C. at 3° C./min and a 1.67 minute hold time. The detector temperature was 300° C.

### Example 1

### Use of a Hollow Cylinder Catalyst for Digestion of Cellulosic Biomass Solids

A ½-inch diameter digester-reactor tube was packed with 6.1 grams of southern pine mini chips (31% moisture) having a nominal size of 8 mm×6 mm×3 mm. 4.9 g of OptiTrap HC 3.2 mm diameter hollow cylinder catalyst (CB 12-032) was packed on top of the wood chips. The catalyst had a nominal composition of 6% Mo and 1.5% Ni and a bulk density of 0.55 g/mL. The catalyst was pre-reduced under excess hydrogen flow with a temperature ramp from 25 to 400° C. at 12.5° C./hour, with a 2 hour hold at the final temperature.

The digester-reactor tube was filled with solvent (45% by weight 1,2-propylene glycol, 5% ethylene glycol by weight in deionized water containing 0.05 wt. % potassium carbonate buffer). Hydrogen flow was introduced at the bottom of the digester-reactor tube, and routed to a high pressure product vessel maintained at 69 bar via pressure regulator, before venting at 9.6 mL/min standard pressure and temperature (STP). The assembly was heated via band heaters (Gaumer) to 190° C., before initiating solvent flow at 0.22 mL/min.

After 1.25 hours, the temperature was ramped to 245° C. and maintained there until 7.5 hours of total run time had elapsed. The pressure drop across the digester-reactor tube was less than 0.5 bar throughout the test, indicating a lack of plugging of the combined bed of hollow cylinder catalyst and digesting wood particulates.

The digester-reactor tube was then cooled, depressurized, and drained of liquid. Undissolved solids were collected via filtration and dried in a vacuum oven overnight at 90° C. Results indicated digestion of 83% of the original wood charge. GC analysis of the liquid product formed in the digester-reactor tube indicated a yield of greater than 39% for conversion of nonvolatile carbohydrates, with boiling points higher than C₆ sugar alcohol, to volatile monohydric alcohols, diols, polyols, and hydrocarbons of higher volatility.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods may also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

1. A biomass conversion system comprising:
a hydrothermal digestion unit;
a first catalytic reduction reactor unit fluidly coupled to the hydrothermal digestion unit along its height by two or more fluid inlet lines and two or more fluid return lines, the first catalytic reduction reactor unit containing a catalyst capable of activating molecular hydrogen; and
a fluid circulation loop comprising the hydrothermal digestion unit and a second catalytic reduction reactor unit that contains a catalyst capable of activating molecular hydrogen.

2. The biomass conversion system of claim 1, wherein the fluid circulation loop is configured to establish countercurrent flow in the hydrothermal digestion unit.

3. The biomass conversion system of claim 1, wherein there are equal numbers of fluid inlet lines and fluid return lines.

4. The biomass conversion system of claim 1, wherein there are 3 to 10 pairs of fluid inlet lines and fluid return lines.

5. The biomass conversion system of claim 1, wherein the fluid inlet lines and fluid return lines are distributed non-uniformly along the height of the hydrothermal digestion unit.

6. The biomass conversion system of claim 1, further comprising:
a solids separation mechanism in fluid communication with at least some of the fluid inlet lines between the hydrothermal digestion unit and the first catalytic reduction reactor unit.

7. The biomass conversion system of claim 1, further comprising:
a solids separation mechanism in fluid communication with the fluid circulation loop between an outlet of the hydrothermal digestion unit and an inlet of the second catalytic reduction reactor unit.

8. The biomass conversion system of claim 1, wherein the first catalytic reduction reactor unit, the second catalytic reduction reactor unit, or both contain a poison-tolerant catalyst.

9. The biomass conversion system of claim 1, wherein the first catalytic reduction reactor unit contains a fixed bed catalyst having a void fraction of at least about 20%.

10. The biomass conversion system of claim 1, further comprising:
a fluid transfer line establishing fluid communication between the first catalytic reduction reactor unit and the fluid circulation loop.

11. The biomass conversion system of claim 1 further comprising at least another first catalytic reduction reactor units fluidly coupled to the hydrothermal digestion unit along its height via a fluid inlet line and a fluid return line.

12. A method comprising:
providing cellulosic biomass solids in a hydrothermal digestion unit;
heating the cellulosic biomass solids in the hydrothermal digestion unit to digest at least a portion of the cellulosic biomass solids, thereby forming a hydrolysate comprising soluble carbohydrates within a liquor phase;
transferring at least a portion of the liquor phase to one or more first catalytic reduction reactor units fluidly coupled to the hydrothermal digestion unit along its height and at least partially transforming the hydrolysate into a reaction product in the one or more first catalytic reduction reactor units;
recirculating at least a portion of the liquor phase from the one or more first catalytic reduction reactor units to the hydrothermal digestion unit; and
transferring at least a portion of the liquor phase to a second catalytic reduction reactor unit so as to further transform the soluble carbohydrates into the reaction product.

13. The method of claim 12, wherein heating the cellulosic biomass solids in the hydrothermal digestion unit takes place at a pressure of at least about 30 bar.

14. The method of claim 12, further comprising:
recirculating at least a portion of the liquor phase from the second catalytic reduction reactor unit to the hydrothermal digestion unit.

15. The method of claim 14, wherein the liquor phase is recirculated from the second catalytic reduction reactor unit to the hydrothermal digestion unit at a recycle ratio ranging between about 0.2 and about 10.

16. The method of claim 15, wherein the liquor phase is recirculated from the second catalytic reduction reactor unit to the hydrothermal digestion unit at a recycle ratio ranging between about 1 and about 2.

17. The method of claim 14, wherein the liquor phase is recirculated from the second catalytic reduction reactor unit to the hydrothermal digestion unit such that countercurrent flow is established in the hydrothermal digestion unit.

18. The method of claim 12, wherein at least about 90% of the cellulosic biomass solids, on a dry basis, are digested to produce hydrolysate.

19. The method of claim 12, wherein the liquor phase is recirculated between the hydrothermal digestion unit and the one or more first catalytic reduction reactor units at a recycle ratio ranging between about 1 and about 30.

20. The method of claim 12, wherein the one or more first catalytic reduction reactor units, the second catalytic reduction reactor unit, or both contains a poison-tolerant catalyst.

21. The method of claim 20, wherein the poison-tolerant catalyst comprises a sulfided catalyst.

22. The method of claim 12, wherein the one or more first catalytic reduction reactor units each contain a fixed bed catalyst having a void fraction of at least about 20%.

23. The method of claim 12, further comprising:
performing a solids separation while transferring the liquor phase between the hydrothermal digestion unit and the one or more first catalytic reduction reactor units.

24. The method of claim 12, further comprising:
performing a solids separation while transferring the liquor phase between the hydrothermal digestion unit and the second catalytic reduction reactor unit.

25. The method of claim 12, wherein the hydrothermal digestion unit operates with a temperature gradient therein; and wherein the liquor phase is transferred to the one or more first catalytic reduction reactor units more rapidly from a higher temperature region of the hydrothermal digestion unit than from a lower temperature region of the hydrothermal digestion unit.
